(19) United States
(12) Patent Application Publication
(10) Pub. No.: US 2025/0372889 A1
(43) Pub. Date: Dec. 4, 2025

(54) ARRAY ANTENNA AND ELECTRONIC DEVICE COMPRISING SAME

(71) Applicant: LG ELECTRONICS INC., Seoul (KR)

(72) Inventors: Seungmin WOO, Seoul (KR); Yusuhk SUH, Seoul (KR); Dongik LEE, Seoul (KR)

(73) Assignee: LG ELECTRONICS INC., Seoul (KR)

(21) Appl. No.: 18/877,942

(22) PCT Filed: Jun. 23, 2022
(86) PCT No.: PCT/KR2022/008964

§ 371 Date: Dec. 20, 2024

(51) Int. Cl. H01Q 21/06; H01Q 19/00

(52) U.S. Cl. CPC H01Q 21/065; H01Q 19/005

(57) ABSTRACT

This electronic device may comprise: a dielectric cover layer; a dielectric cover substrate having a surface mounted to face the dielectric cover layer; a first conductive layer having a first opening and a second opening on the surface of the dielectric cover substrate; a second conductive layer having a third opening and a fourth opening in the dielectric cover substrate; and a phased array antenna on the dielectric cover substrate. Fences of conductive vias in the dielectric cover substrate may be interposed between a first antenna and a second antenna of the phased array antenna and may be connected to the ground.

### TECHNICAL FIELD

This specification relates to an array antenna and an electronic device including the same. One or more embodiments relate to an antenna module including an array antenna implemented in a multi-layer structure and an electronic device including the same.

### BACKGROUND ART

As functions of electronic devices diversify, the electronic devices may be implemented as image display devices such as multimedia players having complex functions, for example, playing music or video files, playing games, receiving broadcasts, and the like.

An image display device is a device for reproducing (playing) image contents. Image display devices receive images (videos) from various sources and reproduce the received images. Image display devices are implemented as various devices such as personal computers (PC), smart phones, tablet PCs, laptop computers, TV sets, and the like. An image display device, such as a smart TV, may provide an application for providing web contents, such as web browsers.

An electronic device, such as the image display device, may include a communication module having antennas to perform communications with neighboring electronic devices. Meanwhile, as a display area (region) of an image display device is expanded recently, an arrangement space of a communication module including antennas is reduced. This causes an increase in necessity of arranging antennas inside a multi-layer circuit board on which the communication module is implemented.

A WiFi radio interface may be considered as an interface for a communication service between electronic devices. When using such a WiFi radio interface, a millimeter wave (mmWave) band may be used for high-speed data transmission between the electronic devices. For example, the high-speed data transmission between the electronic devices is achieved using a radio interface, such as 802.11ay.

In this regard, an array antenna that may operate in a millimeter wave (mmWave) band may be mounted in an antenna module. An antenna module implemented as an array antenna may be configured such that antenna elements are adjacent to each other at a certain gap or less for beamforming. However, there is a problem in that interference between antenna elements may increase as the gap between the antenna elements decreases.

In the antenna module implemented as the array antenna, there is a problem in that unnecessary side radiation components increase and antenna efficiency decreases due to surface wave components through a dielectric region between the antenna elements. The side radiation may cause a decrease in directivity in a front direction of the antenna.

There is also a problem of a narrow operating bandwidth in a planar antenna element, such as a patch antenna element. Therefore, an antenna structure, which achieves high antenna efficiency while operating as a broadband antenna for providing a broadband service in a millimeter wave (mmWave) band, is required.

### DISCLOSURE OF INVENTION

### Technical Problem

One aspect of the specification is to solve the aforementioned problems and other drawbacks. Another aspect of the disclosure is to improve antenna efficiency in a broadband antenna module, which operates in a millimeter wave (mmWave) band.

Still another aspect of the disclosure is to improve efficiency and a directivity in a front direction of an antenna element, which operates in an mmWAve band.

Still another aspect of the disclosure is to propose an antenna structure, which achieves high antenna efficiency while operating as a broadband antenna for providing a broadband service in an mmWave band.

### Solution to Problem

To achieve the above and other purposes according to one or more embodiments, an electronic device may include: a dielectric cover layer; a dielectric substrate having a surface mounted to oppose the dielectric cover layer; a first conductive layer having a first aperture and a second aperture on the surface of the dielectric substrate; a second conductive layer having a third aperture and a fourth aperture inside the dielectric substrate; and a phased array antenna arranged on the dielectric substrate. Fences of conductive vias in the dielectric substrate may be interposed between a first antenna and a second antenna of the phased array antenna and may be connected to the ground.

According to an embodiment, the phased array antenna may include a plurality of patch antenna elements on the surface of the dielectric substrate, and the phased array antenna may be configured to transmit radio-frequency signals at a frequency between 10 GHz and 300 GHz through the dielectric cover layer.

According to an embodiment, a first antenna of the plurality of antenna elements may include a first patch element on the surface of the dielectric substrate, ground traces embedded in the dielectric substrate, and a first transmission line path coupled to a first positive antenna feed on the first patch element. A second antenna of the plurality of antenna elements may include a second patch element on the surface of the dielectric substrate, ground traces embedded in the dielectric substrate, and a second transmission line path coupled to a second positive antenna feed on the second patch element.

According to an embodiment, a first fence of conductive vias in the dielectric substrate may be interposed between the first antenna and the second antenna and may be connected to a ground. The first fence of the conductive vias may extend to a first conductive surface mounted to oppose the dielectric cover layer. The first patch element may be aligned with the first aperture, the second patch element may be aligned with the second aperture, the first transmission line path may be aligned with the third aperture, and the second transmission line path may be aligned with the fourth aperture.

According to an embodiment, a first gap may be a distance between the first patch element and an edge of the first aperture, a second gap may be a distance between the first transmission line path and the first fence of the conductive vias, and a third gap may be a distance between the first transmission line path and an edge of the third aperture. A distance of the second gap may be longer than a distance of the third gap, and a distance of the third gap may be longer than a distance of the first gap.

According to another embodiment, a first antenna of the plurality of antenna elements may include a first parasitic patch element for the first antenna on the surface of the dielectric substrate, a first patch element in the dielectric substrate, ground traces embedded in the dielectric substrate, and a first transmission line path coupled to a first positive antenna feed on the first patch element. A second antenna of the plurality of antenna elements may include a second parasitic patch element for the second antenna on the surface of the dielectric substrate, a second patch element in the dielectric substrate, ground traces embedded in the dielectric substrate, and a second transmission line path coupled to a second positive antenna feed on the first patch element.

According to another embodiment, a first gap may be a distance between the first parasitic patch element and an edge of the first aperture, a second gap may be a distance between the first patch element and the edge of the first aperture, a third gap may be a distance between the first transmission line path and the first fence of the conductive vias, a third gap may be a distance between the first transmission line path and the first fence of the conductive vias, and a fourth gap may be a distance between the first transmission line path and an edge of the third aperture. A distance of the third gap may be longer than a distance of the second gap, the distance of the second gap may be longer than a distance of the first gap, and the distance of the third gap may be longer than a distance of the fourth gap.

According to an embodiment, the first fence of the conductive vias and additional fences of conductive vias may be interposed between the first conductive layer and the second conductive layer, and the first fence of the conductive vias and the additional fences of the conductive vias may be connected to the first conductive layer and the second conductive layer.

According to an embodiment, the first fence of the conductive vias and the additional fences of the conductive vias may include a set of conductive vias having a shape selected from a group consisting of square shapes.

According to an embodiment, the additional fences of the conductive vias may include a second fence of conductive vias, a third fence of conductive vias, and a fourth fence of conductive vias. The first fence of the conductive vias may oppose the third fence of the conductive vias, and the second fence of the conductive vias may oppose the fourth fence of the conductive vias.

According to an embodiment, the second fence of the conductive vias may be arranged adjacent to the first fence of the conductive vias. The first gap may be a distance between a first edge of the first patch element and a first edge of the first aperture adjacent to the first fence of the conductive vias, and a fourth gap may be a distance between a second edge of the first patch element and a second edge of the first aperture adjacent to the second fence of the conductive vias. The distance of the first gap may be longer than a distance of the fourth gap.

According to an embodiment, the first fence of the conductive vias may oppose the third fence of the conductive vias. A fifth gap may be a distance between a third edge of the first patch element and a third edge of the first aperture adjacent to the second fence of the conductive vias. The distance of the first gap may be equal or similar to a distance of the fifth gap.

According to an embodiment, the second fence of the conductive vias may oppose the fourth fence of the conductive vias. A sixth gap may be a distance between a fourth edge of the first patch element and a fourth edge of the first aperture adjacent to the fourth fence of the conductive vias. A distance of the fourth gap may be equal or similar to a distance of the sixth gap.

According to an embodiment, the first transmission line path may be arranged adjacent to the first edge of the first aperture adjacent to the first fence of the conductive vias. The second transmission line path may be arranged adjacent to the first edge of the second aperture adjacent to the first fence of the conductive vias.

According to an embodiment, a seventh gap may be a distance between a first edge of the second patch element and a first edge of the second aperture, and an eighth gap may be a distance between the second transmission line path and the first fence of the conductive vias. A ninth gap may be a distance between the first transmission line path and a first edge of the fourth aperture. A distance of the eighth gap may be longer than a distance of the seventh gap, and a distance of the ninth gap may be longer than the distance of the seventh gap.

According to an embodiment, the plurality of antennas may include a plurality of antenna unit cells, and each antenna unit cell may include a fence of conductive vias. The fence of the conductive vias may extend from the second conductive layer to the first conductive layer through the dielectric substrate, and the fence of the conductive vias, the first conductive layer, and the second conductive layer may define a cavity.

According to another embodiment, the second fence of the conductive vias may be arranged adjacent to the first fence of the conductive vias. The first gap may be a distance between a first edge of the first patch element and a first edge of the first aperture adjacent to the first fence of the conductive vias. A fifth gap may be a distance between a second edge of the first patch element and a second edge of the first aperture adjacent to the second fence of the conductive vias. The distance of the first gap may be longer than a distance of the fifth gap.

According to another embodiment, the first fence of the conductive vias may oppose the third fence of the conductive vias. A sixth gap may be a distance between a third edge of the first patch element and a third edge of the first aperture adjacent to the third fence of the conductive vias. The distance of the first gap may be equal or similar to a distance of the sixth gap.

According to another embodiment, the second fence of the conductive vias may oppose the fourth fence of the conductive vias. A seventh gap may be a distance between a fourth edge of the first patch element and a fourth edge of the first aperture adjacent to the fourth fence of the conductive vias. The distance of the fifth gap may be equal or similar to a distance of the seventh gap.

According to another embodiment, an eighth gap may be a distance between a first edge of the second parasitic patch element and a first edge of the second aperture. A ninth gap may be a distance between a first edge of the second patch element and a first edge of the second aperture, and a tenth gap may be a distance between the second transmission line path and the first fence of the conductive vias. An eleventh gap may be a distance between the second transmission line path and a first edge of the fourth aperture. A distance of the tenth gap may be longer than a distance of the ninth gap, the distance of the ninth gap may be longer than a distance of the eighth gap, and the distance of the tenth gap may be longer than a distance of the eleventh gap.

According to an embodiment, the electronic device may further include a display including a first surface and a second surface, and including a pixel circuit emitting light through the display cover layer and the dielectric cover layer. The display cover may form the first surface of the electronic device, and the dielectric cover layer may be formed adjacent to the display cover layer.

According to an embodiment, the first patch element and the second patch element may be in direct contact with the surface of the dielectric cover layer.

According to an embodiment, the electronic device may further include an adhesive layer configured to attach the dielectric substrate to the dielectric cover layer. The first patch element and the second patch element may be in direct contact with the adhesive layer.

According to an embodiment, the dielectric cover layer may have a first dielectric constant, and the adhesive layer may have a second dielectric constant lower than the first dielectric constant.

According to an embodiment, the radio-frequency signals of the frequency may exhibit an effective wavelength while propagating through the dielectric cover layer. The dielectric cover layer may have a thickness of 0.15 to 0.3 times the effective wavelength.

According to an embodiment, the dielectric cover layer may have a dielectric constant between 3.0 and 10.0.

### Advantageous Effects of Invention

Hereinafter, technical effects of an antenna module operating in a millimeter wave (mmWave) band and an electronic device having the same will be described.

According to an embodiment, antenna efficiency may be improved through a window wall structure, which is formed between antenna elements in a broadband antenna module operating in an mmWave band.

According to an embodiment, a window wall structure, which is formed between antenna elements in a broadband antenna module operating in an mmWave band, may be formed as a via structure on a multi-layer substrate, thereby improving antenna efficiency.

According to an embodiment, a window wall structure may suppress side radiation components, thereby improving efficiency and directivity in a front direction of an antenna element operating in an mmWave band.

According to an embodiment, an antenna structure, which achieves high antenna efficiency while operating as a broadband antenna for providing a broadband service in an mmWave band, may be provided through a stacked antenna structure and a window wall structure.

Further scope of applicability of the disclosure will become apparent from the following detailed description. It should be understood, however, that the detailed description and specific examples, such as the preferred embodiments, are given by way of illustration only, because various changes and modifications within the technical idea and scope of the disclosure will be apparent to those skilled in the art.

### BRIEF DESCRIPTION OF DRAWINGS

FIG. 1 is a schematic view of an example of an entire wireless AV system including an image display device according to an embodiment of the disclosure.

FIG. 2 is a view of a detailed configuration of electronic devices which support radio interfaces according to the disclosure.

FIG. 3A is a view of a request to send (RTS) and a clear to send (CTS) according to the disclosure.

FIG. 3B is a block diagram of a communication system 400 according to an example of the disclosure.

FIG. 4 is a view of an electronic device including a plurality of antenna modules and a plurality of transceiver circuit modules in accordance with an embodiment.

FIG. 5A is a view of a configuration, in which a multi-layer circuit board having an array antenna module is connected to an RFIC, in relation to the disclosure.

FIG. 5B is a conceptual view of antenna structures having different radiation directions.

FIG. 5C is a view of coupling structures between a multi-layer substrate and a main substrate according to embodiments.

FIG. 6 is a conceptual view of a plurality of communication modules arranged on a lower portion of an image display device, and communication performed between components of a corresponding communication module and another communication module arranged in a front direction.

FIG. 7 is a lateral view of an antenna module operating in a millimeter wave band according to the disclosure.

FIG. 8 is a front view of the antenna module of FIG. 7.

FIG. 9 is a view of a structure in which window wall structures are formed on opposite sides of one antenna element of the antenna module of FIG. 7.

FIG. 10 compares antenna gain characteristics according to changes in distances from the center of a patch element to first and second fences of conductive vias.

FIG. 11 is a view of a structure in which window wall structures connected with a ground are formed on opposite sides of antenna elements of the antenna module of FIG. 7.

FIG. 12 compares radiation characteristics and antenna gain characteristics of an antenna module having a C-shaped window wall according to the disclosure with those of a structure without a window wall.

FIG. 13 is a view of a structure, in which a window wall is formed between antenna elements of a phased array antenna according to the disclosure, and electric field distribution depending on presence or absence of the window wall.

FIG. 14 is a lateral view of an antenna module operating in a millimeter wave band according to another aspect of the disclosure.

FIG. 15 is a front view of the antenna module of FIG. 14.

FIG. 16 is a view of a structure in which a dielectric substrate, on which a phased array antenna is formed, is coupled with a dielectric cover layer and a display.

FIG. 17A is a view of a structure in which an antenna module having a first type antenna and a second type antenna as array antennas is arranged on an electronic device.

FIG. 17B is an enlarged view of a plurality of array antenna modules.

FIG. 18 is a view of an antenna module coupled in a different coupling structure at a specific position of an electronic device according to embodiments.

### MODE FOR THE INVENTION

A description will now be given in detail according to one or more embodiments disclosed herein, with reference to the accompanying drawings. For the sake of a brief description with reference to the drawings, the same or like components may be assigned the same reference numeral, regardless of the numerals in the drawings, and a redundant description thereof will be omitted. Suffixes “module” and “unit” used for components used in the following description are merely intended for easy description of the specification, and each suffix itself is not intended to give any special meaning or function. In describing the embodiments disclosed herein, moreover, the detailed description will be omitted when a specific description for publicly known technologies to which the disclosure pertains is judged to obscure the gist of the disclosure. The accompanying drawings are used to help easily understand the technical idea of the disclosure and it should be understood that the idea of the disclosure is not limited by the accompanying drawings. The idea of the present disclosure should be construed to extend to any alterations, equivalents, and substitutes besides the accompanying drawings.

It will be understood that although the terms first, second, and the like may be used herein to describe various elements, these elements should not be limited by these terms. These terms are generally only used to distinguish one element from another.

It will be understood that when an element is referred to as being “connected with” another element, the element may be connected with the another element or intervening elements may also be present. In contrast, when an element is referred to as being “directly connected with” another element, there are no intervening elements present.

The singular forms are intended to include the plural forms as well, unless the context clearly indicates otherwise.

Terms “include” or “has” as used herein should be understood that they are intended to indicate the existence of a feature, a number, a step, an element, a component, or a combination thereof disclosed in the specification, and it may also be understood that the existence or additional possibility of one or more other features, numbers, steps, elements, components, or combinations thereof are not excluded in advance.

Electronic devices described herein may be implemented using a variety of different types of terminals. Examples of such devices may include cellular phones, smart phones, laptop computers, digital broadcasting terminals, personal digital assistants (PDAs), portable multimedia players (PMPs), navigators, slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings may be equally applied to other types of terminals, such as those types noted above. In addition, these teachings may also be applied to stationary terminals, such as digital TV, desktop computers, digital signages, and the like.

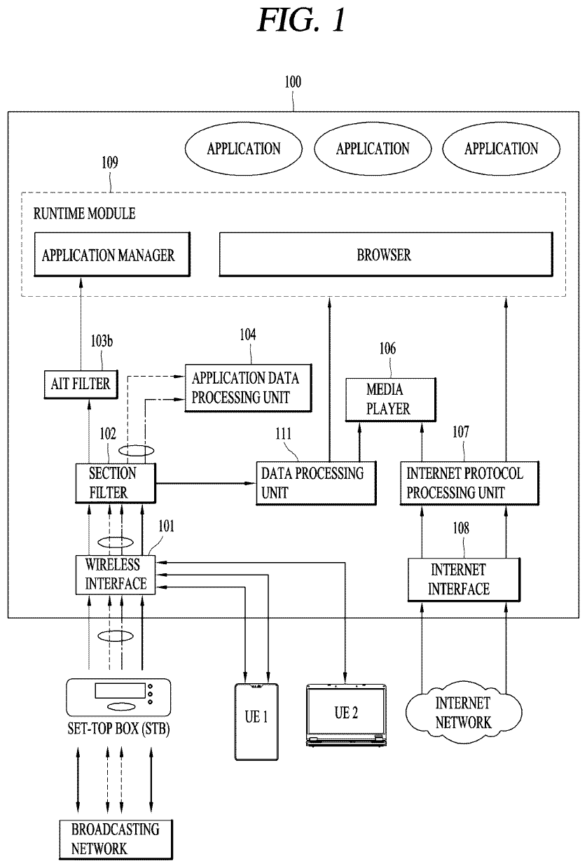

FIG. 1 is a schematic view of an example of an entire wireless AV system including an image display device according to an embodiment of the disclosure.

As illustrated in FIG. 1, an image display device 100 according to another embodiment may be connected to a wireless AV system (or a broadcasting network) and an Internet network. The image display device 100 may be, for example, a network TV, a smart TV, a hybrid broadcast broadband TV (HBBTV), or the like.

The image display device 100 may be wirelessly connected to the wireless AV system (or the broadcasting network) via a wireless interface or wirelessly or wiredly connected to the Internet network via an Internet interface. In relation to this, the image display device 100 may be connected to a server or another electronic device via a wireless communication system. As an example, the image display device 100 needs to provide an 802.11ay communication service which operates in a millimeter wave (mmWave) band to transmit or receive large-capacity data at a high speed.

The mmWave band may be an arbitrary frequency band in a range of 10 GHz to 300 GHz. In this disclosure, the mmWave band may include an 802.11ay band of a 60 GHz band. For example, the mmWave band may include a 5G frequency band of a 28 GHz band or the 802.11ay band of the 60 GHz band. A 5G frequency band may be set to a band of about 24 to 43 GHz and the 802.11ay band may be set to a band of 57 to 70 GHz or 57 to 63 GHZ, but are not limited thereto.

The image display device 100 may wirelessly transmit or receive data to/from an electronic device in the vicinity of the image display device 100, e.g., a set-top box or another electronic device, via a wireless interface. As an example, the image display device 100 may transmit or receive wireless AV data to/from a set-top box or another electronic device, e.g., a mobile terminal, which is arranged in front of or below the image display device 100.

The image display device 100 may include, for example, a wireless interface 101b, a section filter 102b, an application information table (AIT) filter 103b, an application data processing unit 104b, a data processing unit 111b, a media player 106b, an Internet protocol processing unit 107b, an Internet interface 108b, and a runtime module 109b.

Application information table (AIT) data, real-time broadcast content, application data, and a stream event may be received through a broadcast interface 101b. In some embodiments, the real-time broadcast content may be referred to as linear audio/video (A/V) content.

The section filter 102b may perform section filtering on four types of data received through the wireless interface 101b to transmit the AIT data to the AIT filter 103b, the linear A/V content to the data processing unit 111b, and the stream event and the application data to the application data processing unit 104b.

Non-linear A/V content and the application data may be received through the Internet interface 108b. The non-linear A/V content may also be, for example, a content on demand (COD) application. The non-linear A/V content may be transmitted to the media player 106b, and the application data may be transmitted to the runtime module 109b.

Further, the runtime module 109b may include, for example, an application manager and a browser as illustrated in FIG. 1. The application manager may control a life cycle of an interactive application using, for example, the AIT data. The browser may perform, for example, a function of displaying and processing the interactive application.

Hereinafter, a communication module, which includes an antenna for providing a wireless interface in an electronic device such as the above-described image display device, will be described in detail. In relation to this, the wireless interface for communication between electronic devices may be a WiFi wireless interface, but is not limited thereto. As an example, a wireless interface supporting the 802.11ay standard may be provided for high-speed data transmission between electronic devices.

The 802.11ay standard is a successor standard for raising a throughput for the 802.11ad standard to 20 Gbps or greater. An electronic device supporting the 802.11ay wireless interface may be configured to use a frequency band of about 57 to 64 GHz. The 802.11ay wireless interface may be configured to provide backward compatibility for an 802.11ad wireless interface. The electronic device providing the 802.11ay wireless interface may be configured to provide coexistence with a legacy device using the same band.

In relation to a wireless environment for the 802.11ay standard, a coverage of 10 meters or longer in an indoor environment and a coverage of 100 meters or longer in an outdoor environment with a line of sight (LOS) channel condition may be secured.

The electronic device supporting the 802.11ay wireless interface may be configured to provide visual reality (VR) headset connectivity, support server backups, and support cloud applications that require low latency.

An ultra-short range (USR) communication scenario, i.e., a near field communication scenario which is a use case of the 802.11ay wireless interface, is a model for fast large-capacity data exchange between two terminals. The USR communication scenario may be configured to require low power consumption of less than 400 mW, while providing a fast link setup within 100 msec, transaction time within 1 second, and a data rate of 10 Gbps at a very short distance of less than 10 cm.

As the use case of the 802.11ay wireless interface, an 8K UHD wireless transfer at a smart home usage model may be taken into account. In the smart home usage model, a wireless interface between a source device and a sync device may be taken into consideration to stream 8K UHD content at home. In relation to this, the source device may be one of a set-top box, a Blue-ray player, a tablet PC, or a smart phone, and the sink device may be one of a smart TV or a display device, but are not limited thereto. In relation to this, the wireless interface may be configured to transmit uncompressed 8K UHD streaming data (60 fps, 24 bits per pixel, at least 4:2:2) with a coverage of less than 5 m between the source device and the sink device. To this end, the wireless interface may be configured such that data is transmitted between electronic devices at a speed of at least 28 Gbps.

In order to provide such a wireless interface, embodiments related to an array antenna operating in an mmWave band and an electronic device including the array antenna will be described with reference to the accompanying drawings. It will be apparent to those skilled in the art that the disclosure may be embodied in other specific forms without departing from the spirit or essential characteristics of the disclosure.

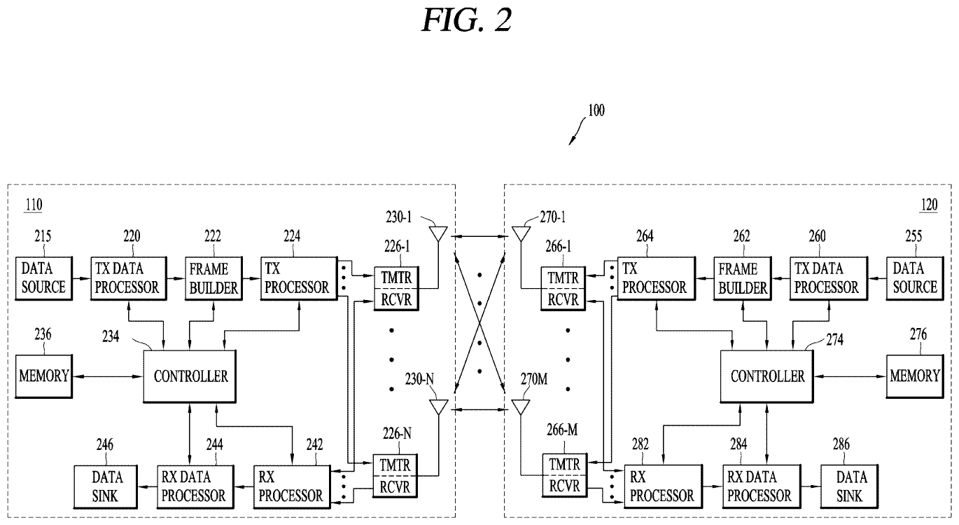

FIG. 2 is a view of a detailed configuration of electronic devices which support radio interfaces according to the disclosure. FIG. 2 is a block diagram of an access point 110 (generally, a first wireless node) and an access terminal 120 (generally, a second wireless node) in a wireless communication system. The access point 110 may be a transmitting entity for downlink transmission and a receiving entity for uplink transmission. The access terminal 120 may be a transmitting entity for uplink transmission and a receiving entity for downlink transmission. As used herein, the “transmitting entity” is an independently operating apparatus or device capable of transmitting data through a wireless channel, and the “receiving entity” is an independently operating apparatus or device capable of receiving data through a wireless channel.

Referring to FIGS. 1 and 2, the set-top box (STB) of FIG. 1 may be the access point 110, and an electronic device, that is, the image display device 100 of FIG. 1 may be the access terminal 120, but are not limited thereto. Accordingly, it should be understood that the access point 110 may alternatively be an access terminal, and the access terminal 120 may alternatively be an access point.

To transmit data, the access point 110 may include a transmission (TX) data processor 220, a frame builder 222, a TX processor 224, a plurality of transceivers 226-1 to 226-N, and a plurality of antennas 230-1 to 230-N. The access point 110 may also include a controller 234 configured to control operations of the access point 110.

To transmit data, the access point 110 may include a transmission (TX) data processor 220, a frame builder 222, a TX processor 224, a plurality of transceivers 226-1 to 226-N, and a plurality of antennas 230-1 to 230-N. The access point 110 may also include a controller 234 configured to control operations of the access point 110.

During operation, the TX data processor 220 may receive data (e.g., data bits) from a data source 215, and process the data for transmission. For example, the TX data processor 220 may encode data (e.g., data bits) into encoded data, and modulate the encoded data into data symbols. The TX data processor 220 may support different modulation and coding schemes (MCSs). For example, the TX data processor 220 may encode data at any one of a plurality of different coding rates (e.g., using low-density parity check (LDPC) encoding). In addition, the TX data processor 220 may modulate the encoded data using any one of a plurality of different modulation schemes including, but not limited to, BPSK, QPSK, 16QAM, 64QAM, 64APSK, 128APSK, 256QAM, and 256APSK.

The controller 234 may transmit, to the TX data processor 220, a command for specifying an MCS to be used (e.g., on the basis of channel conditions for downlink transmission). The TX data processor 220 may encode and modulate the data received from the data source 215 according to the specified MCS. It needs to be recognized that the TX data processor 220 may perform additional processing on the data, for example, data scrambling and/or other processing. The TX data processor 220 may output the data symbols to the frame builder 222.

The frame builder 222 may construct a frame (also referred to as a packet) and insert the data symbols into a data payload of the frame. The frame may include a preamble, a header, and a data payload. The preamble may include a short training field (STF) sequence and a channel estimation (CE) sequence to assist the access terminal 120 in receiving the frame. The header may include information regarding data in a payload, such as a length of the data and an MCS used to encode and modulate the data. Based on this information, the access terminal 120 may demodulate and decode the data. The data in the payload may be partitioned among a plurality of blocks, and each block may contain a part of the data and a guard interval (GI) to assist the receiver in phase tracking. The frame builder 222 outputs the frame to the TX processor 224.

The TX processor 224 processes the frame for transmission on downlink. For example, the TX processor 224 may support different transmission modes, e.g., an orthogonal frequency-division multiplexing (OFDM) transmission mode and a single-carrier (SC) transmission mode. In this example, the controller 234 may transmit, to the TX processor 224, a command for specifying a transmission mode to be used, and the TX processor 224 may process the frame for transmission according to the specified transmission mode. The TX processor 224 may apply a spectrum mask to the frame so that a frequency configuration of a downlink signal complies with particular spectrum requirements.

The TX processor 224 may support multiple-input-multiple-output (MIMO) transmission. In these aspects, the access point 110 may include a plurality of antennas 230-1 to 230-N and a plurality of transceivers 226-1 to 226-N (e.g., one for each antenna). The TX processor 224 may perform spatial processing on incoming frames and provide a plurality of transmission frame streams to a plurality of antennas. The transceivers 226-1 to 226-N receive and process (e.g., convert to analog, amplify, filter, and frequency up-convert) each of the transmission frame streams to generate transmission signals for transmission through the antennas 230-1 to 230-N.

To transmit data, the access terminal 120 includes a TX data processor 260, a frame builder 262, a TX processor 264, a plurality of transceivers 266-1 to 266-M, and a plurality of antennas 270-1 to 270-M (e.g., one antenna per transceiver). The access terminal 120 may transmit data to the access point 110 on uplink and/or transmit the data to another access terminal (e.g., for peer-to-peer communication). The access terminal 120 also includes a controller 274 configured to control operations of the access terminal 120.

The transceivers 266-1 to 266-M receive and process (e.g., convert to analog, amplify, filter, and frequency up-convert) an output from the TX processor 264 for transmission via one or more of the antennas 270-1 to 270-M. For example, the transceiver 266-1 may up-convert the output from the TX processor 264 into a transmission signal having a frequency in a 60 GHz band. Accordingly, the antenna module described herein may be configured to perform a beamforming operation in the 60 GHz band, for example, in a band of about 57 to 63 GHz. In addition, the antenna module may be configured to support MIMO transmission while performing beamforming in the 60 GHz band.

In relation to this, the antennas 270-1 to 270-M and the transceivers 266-1 to 266-M may be implemented in an integrated form on a multi-layer circuit substrate. To do so, among the antennas 270-1 to 270-M, an antenna configured to operate with vertical polarization may be vertically arranged inside the multi-layer circuit substrate.

To receive data, the access point 110 includes a reception (RX) processor 242 and an RX data processor 244. During operation, the transceivers 226-1 to 226-N receive a signal (e.g., from the access terminal 120) and spatially process (e.g., frequency down-convert, amplify, filter, and digitally convert) the received signal.

The RX processor 242 receives outputs from the transceivers 226-1 through 226-N and processes the outputs to recover data symbols. For example, the access point 110 may receive data from a frame (e.g., from the access terminal 120). In this example, the RX processor 242 may detect a start of the frame using a short training field (STF) sequence in a preamble of the frame. The RX processor 242 may also use the STF for automatic gain control (AGC) adjustment. The RX processor 242 may also perform channel estimation (e.g., using a channel estimation (CE) sequence in the preamble of the frame), and perform channel equalization on the received signal based on the channel estimation.

The RX data processor 244 receives data symbols from the RX processor 242 and an indication of a corresponding MSC scheme from the controller 234. The RX data processor 244 demodulates and decodes the data symbols, recovers the data according to the indicated MSC scheme, and stores and/or outputs the recovered data (e.g., data bits) to a data sink 246 for additional processing.

The access terminal 120 may transmit the data using an orthogonal frequency-division multiplexing (OFDM) transmission mode or a single-carrier (SC) transmission mode. In this case, the RX processor 242 may process the received signal according to a selected transmission mode. In addition, as described above, the TX processor 264 may support MIMO transmission. In this case, the access point 110 includes the antennas 230-1 to 230-N and the transceivers 226-1 to 226-N (e.g., one for each antenna). Accordingly, the antenna module described herein may be configured to perform a beamforming operation in the 60 GHz band, for example, in a band of about 57 to 63 GHZ. In addition, the antenna module may be configured to support MIMO transmission while performing beamforming in the 60 GHz band.

In relation to this, the antennas 230-1 to 230-M and the transceivers 226-1 to 226-M may be implemented in an integrated form on a multi-layer circuit substrate. To do so, among the antennas 230-1 to 230-M, an antenna configured to operate with vertical polarization may be vertically arranged inside the multi-layer circuit substrate.

Meanwhile, each transceiver receives and processes (e.g., frequency down-converts, amplifies, filters, and digitally converts) a signal from each antenna. The RX processor 242 may perform spatial processing on the outputs from the transceivers 226-1 to 226-N to recover the data symbols.

The access point 110 also includes a memory 236 coupled to the controller 234. The memory 236 may store commands that, when executed by the controller 234, cause the controller 234 to perform one or more of the operations described herein. Similarly, the access terminal 120 also includes a memory 276 coupled to the controller 274. The memory 276 may store commands that, when executed by the controller 274, cause the controller 274 to perform one or more of the operations described herein.

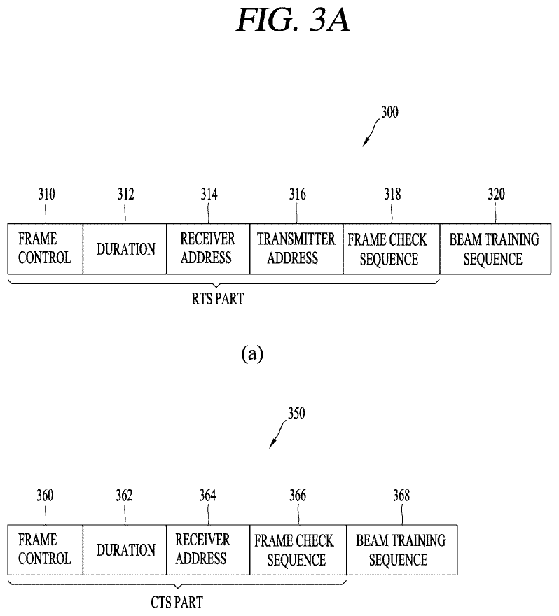

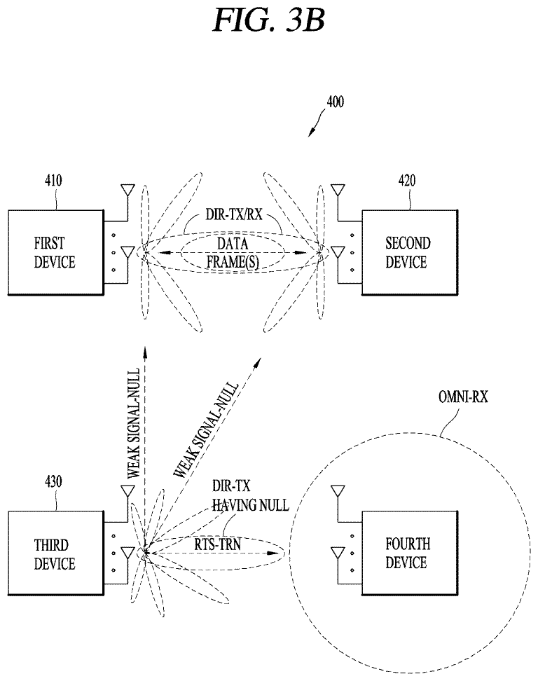

Meanwhile, an electronic device supporting 802.11ay wireless interface according to the present disclosure determines whether or not a communication medium is available to communicate with other electronic devices. To this end, the electronic device transmits a Request to Send (RTS)-TRN frame including an RTS part and a first beam training sequence. In this regard, FIG. 3A illustrates a Request to Send (RTS) and a Clear to Send (CTS) according to the present disclosure. A transmitting device may use an RTS frame to determine whether a communication medium is available to transmit one or more data frames to a destination device. In response to the reception of the RTS frame, the destination device transmits a CTS frame to the transmitting device when the communication medium is available. In response to the reception of the CTS frame, the transmitting device transmits the one or more data frames to the destination device. In response to the successful reception of the one or more data frames, the destination device transmits one or more acknowledgment (“ACK”) frames to the transmitting device.

Referring to (a) of FIG. 3A, a frame 300 includes an RTS part including a frame control field 310, a duration field 312, a receiver address field 314, a transmitter address field 316, and a frame check sequence field 318. For the purpose of improved communication and interference reduction, the frame 300 further includes a beam training sequence field 320 to configure antennas of a destination device and one or more neighboring devices, respectively.

Referring to (b) of FIG. 3A, a CTS frame 350 includes a CTS part including a frame control field 360, a duration field 362, a receiver address field 314, and a frame check sequence field 366. For the purpose of improved communication and interference reduction, the frame 350 further includes a beam training sequence field 368 to configure antennas of a transmitting device and one or more neighboring devices, respectively.

The beam training sequence fields 320 and 368 may comply with the training (TRN) sequence in accordance with IEEE 802.11ad or 802.11ay. The transmitting device may use the beam training sequence field 368 to configure its antenna for directional transmission to the destination device. On the other hand, the transmitting devices may use the beam training sequence field to configure their own antennas to reduce transmission interference at the destination device. In this case, the transmitting devices may use the beam training sequence field to configure their own antennas to generate antenna radiation patterns with nulls aimed at the destination device.

Therefore, electronic devices supporting 802.11 ay wireless interface may form initial beams to have a low interference level therebetween using beamforming patterns determined according to the beam training sequence. In this regard, FIG. 3B is a block diagram illustrating a communication system 400 according to an example of the present disclosure. As illustrated in FIG. 3B, first and second devices 410 and 420 may improve communication performance by matching directions of main beams. On the other hand, the first and second devices 410 and 420 may form signal-null having weak signal intensity in a specific direction, in order to reduce interference with a third device 430.

In relation to the formation of the main beam and the signal-null, a plurality of electronic devices according to the present disclosure may perform beamforming through array antennas. Referring to FIG. 3B, some of the plurality of electronic devices may alternatively be configured to perform communication with an array antenna of another electronic device through a single antenna. In this regard, when performing communication through the single antenna, a beam pattern is formed as an omnidirectional pattern.

Referring to FIG. 3B, the first to third devices 410 to 430 perform beamforming but a fourth device 440 does not perform beamforming, but the present disclosure is not limited thereto. Therefore, it may alternatively be configured such that three of the first to fourth devices 410 to 440 perform beamforming and the other may not perform beamforming.

As another example, it may be configured such that any one of the first to fourth devices 410 to 440 performs beamforming and the remaining three devices do not perform beamforming. As still another example, it may be configured such that two of the first to fourth devices 410 to 440 perform beamforming and the remaining two devices do not perform beamforming. As still another example, all the first to fourth devices 410 to 440 may be configured to perform beamforming.

Referring to FIGS. 3A and 3B, the first device 410 determines that it is an intended receiving device of the CTS-TRN frame 350 on the basis of an address displayed on the receiver address field 364 of the CTS-TRN frame 350. In response to the determination as the intended receiving device of the CTS-TRN frame 350, the first device 410 may use the beam training sequence of the beam training sequence field 368 of the received CTS-TRN 350 to configure its own antenna for a directional transmission substantially and selectively aimed at the second device 420. That is, the antenna of the first device 410 is configured to generate a primary lobe (e.g., highest gain lobe) substantially aimed at the second device 420, and an antenna radiation pattern with non-primary lobes aimed at other directions.

The second device 420 already knows the direction toward the first device 410 based on the beam training sequence of the beam training sequence field 320 of the previously-received RTS-TRN frame 300. Therefore, the second device 420 may configure its own antenna for a directional reception (e.g., primary antenna radiation lobe) selectively aimed at the first device 410. Therefore, while the antenna of the first device 410 is configured for the directional transmission toward the second device 420 and the antenna of the second device 420 is configured for the directional reception from the first device 410, the first device 410 transmits one or more data frames to the second device 420. Accordingly, the first and second devices 410 and 420 perform directional transmission/reception (DIR-TX/RX) of the one or more data frames through the primary lobe (main beam).

On the other hand, the first and second devices 410 and 420 may partially modify the beam pattern of the third device 430 to reduce interference with the third device 430 due to an antenna radiation pattern with the non-primary lobes.

In this regard, the third device 430 determines that it is not an intended receiving device of the CTS-TRN frame 350 on the basis of an address indicated in the receiver address field 364 of the CTS-TRN frame 350. In response to the determination that it is not the intended receiving device of the CTS-TRN frame 350, the third device 430 uses the beam training sequence of the beam training sequence field 368 of the received CTS-TRN 350 and the sequence of the beam training sequence field 320 of the previously-received RTS-TRN frame 300, in order to configure its antenna to generate antenna radiation patterns each with nulls substantially aimed at the second device 420 and the first device 410. The nulls may be based on estimated arrival angles of the previously-received TRS-TRN frame 300 and CTS-TRN frame 350. In general, the third device 430 generates antenna radiation patterns with desired signal power, refusals, or gains aimed at the first device 410 and the second device 420 such that estimated interferences at the devices 410 and 420 are equal to or lower than a defined threshold value (e.g., to achieve a desired bit error rate (BER), signal-to-noise ratio (SNR), signal-to-interference ratio (SINR), and/or other one or more communication attributes).

The third device 430 may configure its antenna transmission radiation pattern by estimating antenna gains in directions toward the first and second devices 410 and 420, estimating antenna mutuality differences (e.g., transmitting antenna gain-receiving antenna gain) between the third device 430 and the first and second devices 410 and 420, and calculating those values over one or more sectors for determining corresponding estimated interferences at the first and second devices 410 and 420.

The third device 430 transmits the RTS-TRN frame 300 intended for the fourth device 440, which the fourth device 440 receives. The third device 430 maintains an antenna configuration with nulls aimed at the first and second devices 410 and 420 as long as the first device 410 and the second device 420 are communicating based on durations displayed on the duration fields 312 and 362 of the RTS-TRN frame 300 and the CTS-TRN frame 350, respectively. As the antenna of the third device 430 is configured to produce the nulls aimed at the first device 410 and the second device 420, the transmission of the RTS-TRN frame 300 by the third device 430 may produce reduced interferences at the first device 410 and the second device 420.

Therefore, electronic devices supporting the 802.11ay wireless interface disclosed herein can form a signal-null to a specific direction for interference reduction while matching a main beam direction therebetween using array antennas. To this end, the plurality of electronic devices may form an initial beam direction through a beam training sequence, and change the beam direction through the periodically updated beam training sequence.

As aforementioned, the beam directions should be matched between the electronic devices for high-speed data communication between the electronic devices. Also, the loss of wireless signals transmitted to an antenna element should be minimized for the high-speed data communication. To this end, the array antenna should be disposed inside a multi-layer substrate on which an RFIC is disposed. Also, the array antenna is necessarily disposed adjacent to a side area inside the multi-layer substrate for radiation efficiency.

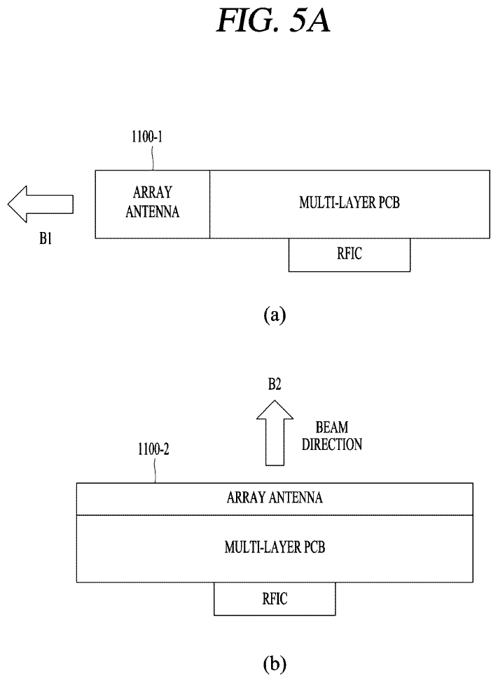

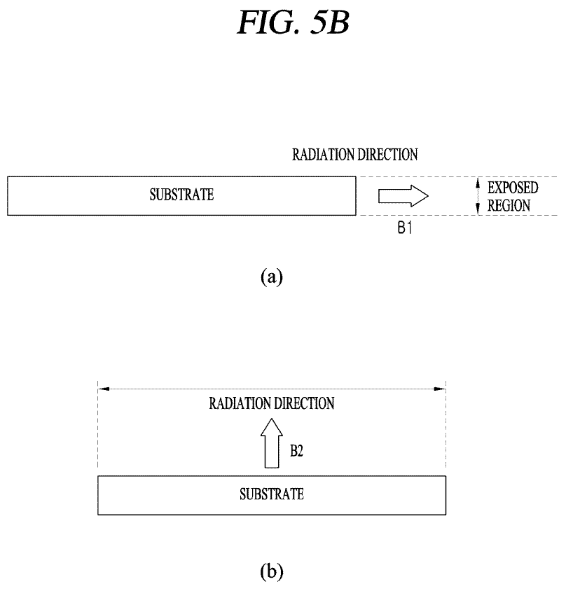

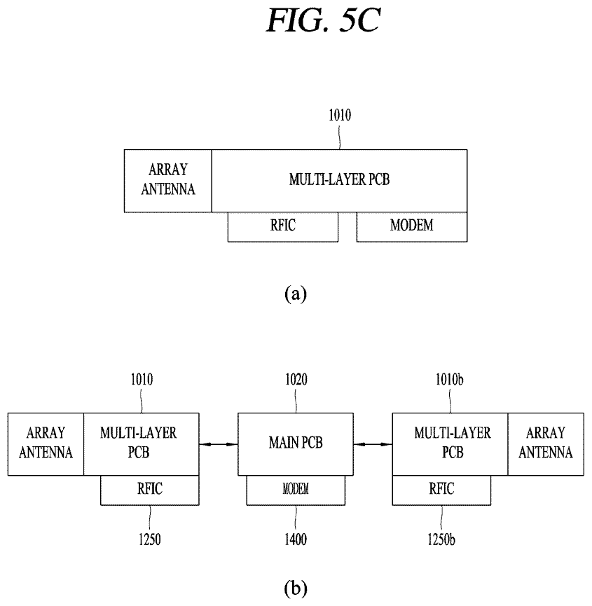

In addition, the beam training sequence should be updated to adapt to the change of a wireless environment. To update the beam training sequence, the RFIC should periodically transmit and receive signals to and from a processor such as a modem. Therefore, control signal transmission and reception between the RFIC and the modem should also be carried out within fast time to minimize an update delay time. To this end, a physical length of a connection path between the RFIC and the modem should be reduced. To this end, the modem may be disposed on the multi-layer substrate on which the array antenna and the RFIC are disposed. Or, in the structure that the array antenna and the RFIC are disposed on the multi-layer substrate and the modem is disposed on a main substrate, the connection length between the RFIC and the modem may be minimized. A detailed structure thereof will be described later with reference to FIG. 5C.

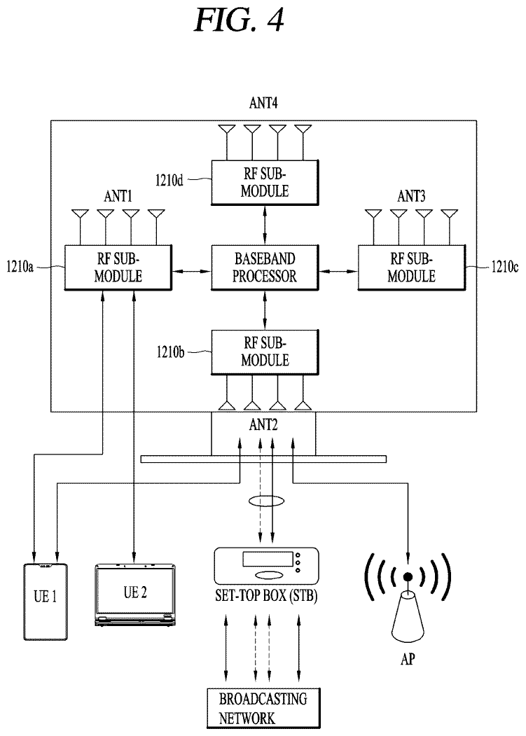

Hereinafter, an electronic device having an array antenna that can operate in an mmWave band will be described. In this regard, FIG. 4 is a diagram illustrating an electronic device including a plurality of antenna modules and a plurality of transceiver circuit modules in accordance with one embodiment. Referring to FIG. 4, a home appliance in which a plurality of antenna modules and a plurality of transceiver circuit modules are disposed may be a television, but is not limited thereto. Therefore, the home appliance having the plurality of antenna modules and the plurality of transceiver circuit modules disclosed herein may include an arbitrary home appliance or display device that supports a communication service in a millimeter wave band.

Referring to FIG. 4, the electronic device 1000 includes a plurality of antenna modules ANT1 to ANT4 and a plurality of transceiver circuit modules 1210a to 1210d. In this regard, the plurality of transceiver circuit modules 1210a to 1210d may correspond to the aforementioned transceiver circuit 1250. Or, the plurality of transceiver circuit modules 1210a to 1210d may be a partial configuration of a transceiver circuit 1250 or a partial configuration of a front end module disposed between the antenna module and the transceiver circuit 1250.

The plurality of antenna modules ANT1 to ANT4 may be configured as array antennas with a plurality of antenna elements. The number of elements of each antenna module ANT1 to ANT4 may be two, three, four, and the like as aforementioned, but it not limited thereto. For example, the number of antenna modules ANT1 to ANT4 may be expanded to two, four, eight, sixteen, and the like. Also, the elements of the antenna modules ANT1 to ANT4 may be selected by the same number or different numbers. The plurality of antenna modules ANT1 to ANT4 may be disposed on different areas of the display or on a bottom or side surface of the electronic device. The plurality of antenna modules ANT1 to ANT4 may be disposed on top, left, bottom, and right sides of the display, but the present disclosure is not limited thereto. As another example, the plurality of antenna modules ANT1 to ANT4 may alternatively be disposed on a left top portion, a right top portion, a left bottom portion, and a right bottom portion of the display.

The antenna modules ANT1 to ANT4 may be configured to transmit and receive signals at an arbitrary frequency band in a specific direction. For example, the antenna modules ANT1 to ANT4 may operate at one of 20 GHz band, 39 GHz band, and 64 GHz band.

The electronic device may maintain a connection state with different entities through two or more of the antenna modules ANT1 to ANT4 or perform data transmission or reception therefor. In this regard, the electronic device corresponding to the display device may transmit or receive data to or from a first entity through the first antenna module ANT1. The electronic device may transmit or receive data to or from a second entity through the second antenna module ANT2. As one example, the electronic device may transmit or receive data to or from a mobile terminal (User Equipment (UE)) through the first antenna module ANT1. The electronic device may transmit or receive data to or from a control device such as a set-top box or access point (AP) through the second antenna module ANT2.

The electronic device may transmit or receive data to or from other entities through the other antenna modules, for example, the third antenna module ANT3 and the fourth antenna module ANT4. As another example, the electronic device may perform dual connectivity or MIMO with at least one of previously-connected first and second entities through the third antenna module ANT3 and the fourth antenna module ANT4.

The mobile terminals UE1 and UE2 may be disposed on a front area of the electronic device to communicate with the first antenna module ANT1. On the other hand, the set-top box STB or the AP may be disposed on a bottom area of the electronic device to communicate with the second antenna module ANT2 but is not limited thereto. As another example, the second antenna module ANT2 may include a first antenna radiating a signal to the bottom area, and a second antenna radiating a signal to a front area. Therefore, the second antenna module ANT2 may perform communication with the set-top box STB or the AP through the first antenna, and perform communication with one of the mobile terminals UE1 and UE2 through the second antenna.

Meanwhile, one of the mobile terminals UE1 and UE2 may be configured to perform MIMO with the electronic device. As one example, the UE1 may be configured to perform MIMO while performing beamforming with the electronic device. As aforementioned, the electronic device corresponding to the image display device may perform high-speed communication with another electronic device or set-top box through a WiFi wireless interface. As one example, the electronic device may perform high-speed communication with another electronic device or set-top box at 60 GHz through 802.11ay wireless interface.

In the meantime, the transceiver circuit modules 1210a to 1210d may operate to process transmission signals and reception signals at RF frequency bands. Here, the RF frequency bands, as aforementioned, may be arbitrary mmWave frequency bands, such as 28 GHz, 39 GHz, and 64 GHz. The transceiver circuit modules 1210a to 1210d may be referred to as RF sub-modules 1210a to 1210d. At this time, the number of RF sub-modules 1210a to 1210d may not be limited to four, but may vary to an arbitrary number more than two depending on an application.

Also, the RF sub-modules 1210a to 1210d may include an up-conversion module and a down-conversion module that convert a signal of an RF frequency band into a signal of an IF frequency band or a signal of an IF frequency band into a signal of an RF frequency band. To this end, the up-conversion module and the down-conversion module may include a local oscillator (LO) that can perform up-frequency conversion and down-frequency conversion.

The plurality of RF sub-modules 1210a to 1210d may be configured such that a signal is transmitted from one of the plurality of transceiver circuit modules to an adjacent transceiver circuit module. Accordingly, the transmitted signal may be transmitted at least one time to all of the plurality of transceiver circuit modules 1210a to 1210d.

To this end, a data transfer path in a loop structure may be additionally provided. In this regard, the adjacent RF sub-modules 1210b and 1210c may be allowed to perform a bi-directional signal transfer through a transfer path P2 with the loop structure.

Or, a data transfer path in a feedback structure may be additionally provided. In this regard, at least one RF sub-module 1210c may be allowed to perform a uni-directional signal transfer to the other RF sub-modules 1210a, 1210b, and 1210c through the data transfer path with the feedback structure.

The plurality of RF sub-modules may include a first RF sub-module to a fourth RF sub-module 1210a to 1210d. In this regard, a signal may be transferred from the first RF sub-module 1210a to the adjacent second RF sub-module 1210B and fourth RF sub-module 1210d. Also, the second RF sub-module 1210b and the fourth RF sub-module 1210d may transfer the signal to the third RF sub-module 1210c. At this time, when the second RF sub-module 1210b and the third RF sub-module 1210c are available to transmit signals bidirectionally, it may be referred to as the loop structure. On the other hand, when the second RF sub-module 1210b and the third RF sub-module 1210c are available to merely transmit signals unidirectionally, it may be referred to as the feedback structure. In the feedback structure, at least two signals may be transferred to the third RF sub-module 1210c.

However, with no limit to this, the baseband module may be disposed in a specific module of the first to fourth RF sub-modules 1210a to 1210d depending on applications. Or, depending on applications, the baseband module may not be disposed in the first to fourth RF sub-modules 1210a to 1210d, but may be configured as a separate controller, namely, a baseband processor 1400. For example, a control signal transfer may alternatively be carried out only by the separate controller, namely, the baseband processor 1400.

Hereinafter, a description will be given of detailed configuration and functions of the electronic device, as illustrated in FIG. 1, having wireless interfaces as illustrated in FIG. 2. Electronic devices need to perform data transmission and reception between the electronic devices using communication services in an mmWAve band. In this regard, wireless audio-video (AV) service and/or high-speed data transmission may be provided by using 802.11ay wireless interface as the mmWave wireless interface. In this case, the mmWAve wireless interface is not limited to the 802.11ay wireless interface, but an arbitrary wireless interface of 60 GHz may be applied. In this regard, a 5G or 6G wireless interface that uses 28 GHz band or 60 GHz band may alternatively be used for high-speed data transmission between electronic devices.

There is no detailed solution to antenna and radio frequency integrated chip (RFIC) providing a wireless interface in an electronic device, such as an image display device, for transferring images with resolution of at least 4K. Specifically, considering a situation that the electronic device, such as the image display device, is disposed on a wall of a building or a table, the electronic device need to transmit or receive wireless AV data to or from another electronic device. To this end, a detailed configuration and antenna structure for determining an area of the image display device to dispose the antenna and RFIC should be proposed.

In this regard, FIG. 5A is a view of a configuration, in which a multi-layer circuit board having an array antenna module is connected to an RFIC, in relation to the disclosure. In some embodiments, FIG. 5A is a view of an antenna in package (AIP) module structure and an antenna module structure implemented on a flexible substrate, in relation to the disclosure.

Referring to (a) of FIG. 5A, the AIP module may be disposed for mmWave band communication, and may be configured in an integral form of RFIC-PCB-antenna. In this regard, an array antenna module 1100-1, as illustrated in (a) of FIG. 5, may be formed integrally with a multi-layer PCB. Therefore, the array antenna module 1100-1 integrally formed with the multi-layer PCB may be referred to as the AIP module. For example, the array antenna module 1100-1 may be arranged on one side area of the multi-layer PCB. Accordingly, a first beam B1 may be formed toward the side area of the multi-layer PCB by using the array antenna module 1100-1 disposed on the one side area of the multi-layer PCB.

In some embodiments, referring to (b) of FIG. 5A, an array antenna module 1100-2 may be arranged on top of the multi-layer PCB. The arrangement of the array antenna module 1100-2 is not limited to the structure of (b) of FIG. 5A, but may be arranged on an arbitrary layer inside the multi-layer PCB. Accordingly, a second beam B2 may be formed toward a front area of the multi-layer PCB by using the array antenna module 1100-2 arranged on the arbitrary layer of the multi-layer PCB. The AIP module integrally formed with the array antenna module may be configured such that an array antenna is arranged on the same PCB to minimize a distance between the RFIC and the antenna.

For example, the antenna of the AIP module may be produced through a multi-layer PCBA manufacturing process, and may radiate a signal in a vertical/lateral direction of the PCB. In this regard, dual polarization may be realized by using a patch antenna, a dipole/monopole antenna, or the like. Therefore, the first array antenna 1100-1 of (a) of FIG. 5A may be arranged on the side area of the multi-layer PCB and the second array antenna 1100-2 of (b) of FIG. 5A may be arranged on the side area of the multi-layer PCB. Accordingly, the first beam B1 may be generated through the first array antenna 1100-1 and the second beam B2 may be generated through the second array antenna 1100-2.

The first array antenna 1100-1 and the second array antenna 1100-2 may be configured to be in the same polarization. Or, the first array antenna 1100-1 and the second array antenna 1100-2 may be configured to be in orthogonal polarizations to each other. In this regard, the first array antenna 1100-1 may operate as a vertically polarized antenna and the second array antenna 1100-2 may operate as a horizontally polarized antenna. As one example, the first array antenna 1100-1 may be a monopole antenna having the vertical polarization and the second array antenna may be a patch antenna having the horizontal polarization.

In some embodiments, FIG. 5B is a conceptual view of antenna structures having different radiation directions.

Referring to (a) of FIG. 5A and (a) of FIG. 5B, a radiation direction of an antenna module arranged on the side area of the multi-layer PCB may correspond to a lateral (side) direction. In relation, an antenna implemented on a flexible substrate may be configured as radiation elements such as dipole/monopole antennas. That is, the antennas implemented on the flexible substrate may include end-fire antenna elements.

End-fire radiation may be implemented by an antenna that radiates a signal in a horizontal direction with respect to a substrate. The end-fire antenna may be implemented as a dipole/monopole antenna, a Yagi dipole antenna, a Vivaldi antenna, a SIW horn antenna, or the like. Here, the Yagi-dipole antenna and the Vivaldi antenna may have horizontal polarization characteristics. In some embodiments, one of antenna modules arranged on the image display device disclosed herein may require for a vertically polarized antenna. Therefore, there is a need of proposing an antenna structure capable of minimizing an exposed portion of an antenna while operating as a vertically polarized antenna.

Referring to (b) of FIG. 5A and (a) of FIG. 5B, a radiation direction of an antenna module arranged on the front area of the multi-layer PCB may correspond to a front direction. In relation, antennas arranged on the AIP module may be configured as radiation elements such as patch antennas. That is, the antennas arranged on the AIP module may include broadside antenna elements that radiate in a broadside direction.

In some embodiments, a multi-layer PCB in which an array antenna is arranged may be integrally formed with a main substrate or may be modularly coupled to the main substrate by a connector. In this regard, FIG. 5C is a view of coupling structures between a multi-layer substrate and a main substrate in accordance with embodiments. Referring to (a) of FIG. 5C, a structure in which an RFIC 1250 and a modem 1400 are integrally formed on the multi-layer PCB 1010 is illustrated. The modem 1400 may be referred to as a baseband processor 1400. Therefore, the multi-layer PCB 1010 may be integrally formed with the main substrate. The integral structure may be applied to a structure in which only one array antenna module is arranged in an electronic device.

In some examples, the multi-layer PCB 1010 and the main substrate 1020 may be modularly coupled to each other by a connector. Referring to (b) of FIG. 5C, the multi-layer PCB 1010 may be interfaced with the main substrate 1020 through the connector. In this instance, the RFIC 1250 may be arranged on the multi-layer PCB 1010 and the modem 1400 may be disposed on the main substrate 1020. Accordingly, the multi-layer PCB 1010 may be produced as a separate substrate from the main substrate 1020 and coupled to the main substrate 1020 through the connector.

The modular structure may be applied to a structure in which a plurality of array antenna modules are arranged in an electronic device. Referring to (b) of FIG. 5C, the multi-layer PCB 1010 and a second multi-layer PCB 1010b may be interfaced with the main substrate 1020 through connectors. The modem 1400 arranged on the main substrate 1020 may be electrically coupled to RFICs 1250 and 1250b, which are arranged on the multi-layer PCB 1010 and the second multi-layer PCB 1010b.

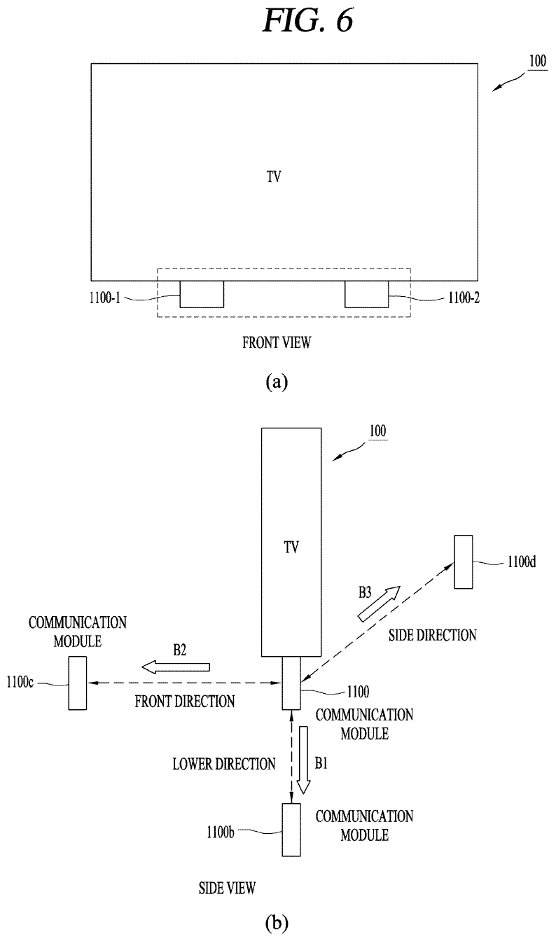

In some embodiments, when the AIP module is arranged beneath the electronic device such as the image display device, it is necessary to communicate with other communication modules arranged in a lower direction and a front direction. In this regard, FIG. 6 is a conceptual view of a plurality of communication modules arranged on a lower portion of an image display device, and communication performed between components of a corresponding communication module and another communication module arranged in a front direction. Referring to (a) of FIG. 6, different communication modules 1100-1 and 1100-2 may be arranged on the lower portion of the image display device 100. Referring to (b) of FIG. 6, the image display device 100 may perform communication with a communication module 1100b arranged below the image display device 100 through an antenna module 1100. The image display device 100 may perform communication with a second communication module 1100c arranged at the front of the image display device 100 through the antenna module 1100. The image display device 100 may also perform communication with a third communication module 1100d arranged at a lateral side of the image display device 100 through the antenna module 1100.

Here, the communication module 1100b may be a set-top box or AP that transfers AV data to the image display device 100 at high speed through the 802.11ay wireless interface, but is not limited thereto. Also, the second communication module 1100c may be an arbitrary electronic device that transmits and receives data at high speed to and from the image display device 100 through the 802.11ay wireless interface. In some embodiments, to perform wireless communication with communication modules 1100b, 1100c, and 1100d arranged on the front, lower, and lateral sides, the antenna module 1100 having a plurality of array antennas may form beams in different directions. In some embodiments, the antenna module 1100 may form beams in a front direction B1, a lower direction B2, and a side direction B3 through different array antennas.

An antenna height may increase according to an RFIC drive circuit and a heat dissipation structure in the AIP module structure as illustrated in (a) of FIG. 5A. Also, the antenna height may increase in the AIP module structure as illustrated in (a) of FIG. 5A according to an antenna type used. For example, the antenna module structure implemented on the side area of the multi-layer substrate as illustrated in (b) of FIG. 5A may be implemented as a low-profile type.

Hereinafter, a description will be given of detailed configurations of the antenna modules of FIGS. 5A to 5C to be arranged inside or on a side surface of the electronic device of FIGS. 4 and 6, in the electronic device as illustrated in FIGS. 1 and 2.

An electronic device, such as an image display device, may include a communication module having antennas to perform communications with neighboring electronic devices. In some embodiments, as a display area (region) of the image display device is expanded recently, an arrangement space of a communication module including antennas may be reduced. This may cause an increase in necessity of arranging antennas inside a multi-layer printed circuit board (PCT) on which the communication module is implemented.

In some embodiments, a WiFi wireless interface may be considered as an interface for a communication service between electronic devices. When using such a WiFi wireless interface, a millimeter wave (mmWave) band may be used for high-speed data transmission between the electronic devices. In particular, the high-speed data transmission between the electronic devices may be achieved using a wireless interface, such as 802.11ay.

In this regard, an array antenna that may operate in a millimeter wave (mmWave) band may be mounted in an antenna module. An antenna module implemented as an array antenna may be configured such that antenna elements are adjacent to each other at a certain gap or less for beamforming. However, there is a problem in that interference between antenna elements may increase as the gap between the antenna elements decreases.

In the antenna module implemented as the array antenna, there is a problem in that unnecessary side radiation components increase and antenna efficiency decreases due to surface wave components through a dielectric region between the antenna elements. The side radiation may cause a decrease in directivity in a front direction of the antenna. There is also a problem of a narrow operating bandwidth in a flat antenna element, such as a patch antenna element. Therefore, an antenna structure, which achieves high antenna efficiency while operating as a broadband antenna for providing a broadband service in a millimeter wave (mmWave) band, is required.

The specification is intended to solve the aforementioned problems and other drawbacks, and to improve antenna efficiency in a broadband antenna module operating in a millimeter wave band.

Another aspect of the disclosure is to improve efficiency and a directivity in a front direction of an antenna element, which operates in an mmWAve band.

Still another aspect of the disclosure is to propose an antenna structure, which achieves high antenna efficiency while operating as a broadband antenna for providing a broadband service in an mmWave band.

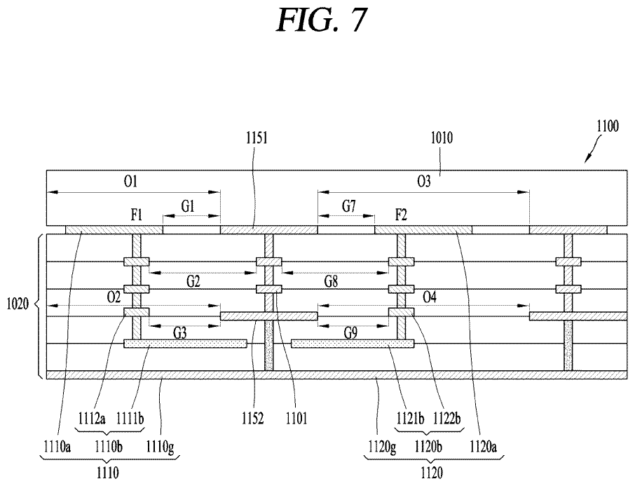

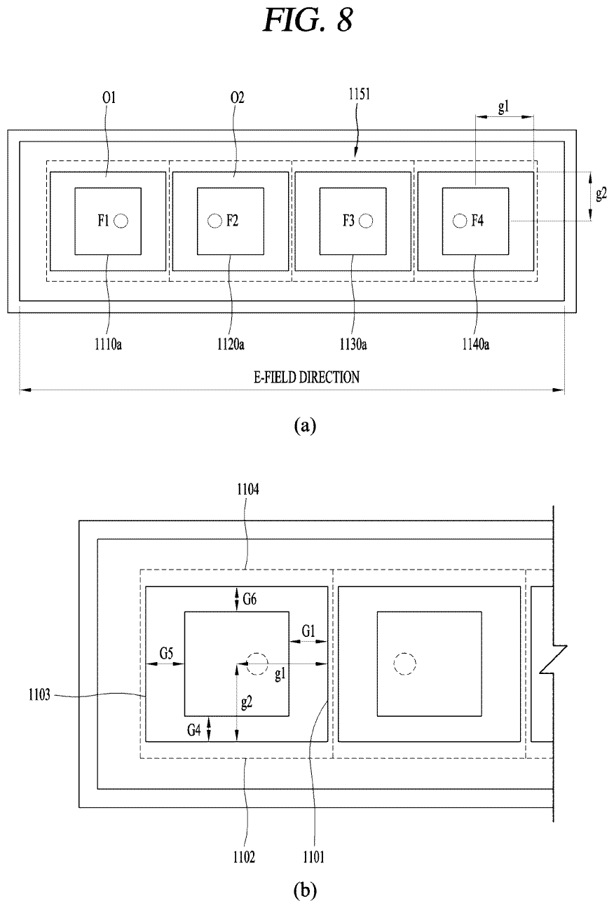

Hereinafter, an antenna module operating in a millimeter wave band and an electronic device including the same according to the disclosure will be described. In this regard, FIG. 7 is a lateral view of an antenna module operating in a millimeter wave band according to the disclosure. FIG. 8 is a front view of the antenna module of FIG. 7. (a) of FIG. 8 is a front view of a window wall structure in which a plurality of antenna elements 1110a to 1110d are surrounded by a conductive layer 1151 on the same plane. (b) of FIG. 8 is an enlarged view of (a) of FIG. 8, namely, a front view of a window wall structure in which one of the antenna elements is surrounded by fences 1101 to 1104 of conductive vias.

Referring to FIGS. 7 and 8, the electronic device may include an antenna module. The antenna module may include a dielectric cover layer 1010, a dielectric substrate 1020, and a phased array antenna 1110. The antenna module may further include a first conductive layer 1151 and a second conductive layer 1152.

The dielectric cover layer 1010 may be arranged in an upper region of the dielectric substrate 1020. The dielectric cover layer 1010 may be formed as a dielectric structure of the electronic device and may act as a cover or radome to suppress the phased array antenna 1100 from being exposed to the outside. The dielectric substrate 1020 may be formed to have a surface which is mounted to oppose the dielectric cover layer 1010. The dielectric substrate 1020 may include a plurality of dielectric layers and a plurality of conductive layers. The dielectric substrate 1020 may be configured as a multi-layer substrate which includes a plurality of dielectric layers and a plurality of conductive layers.

The phased array antenna 1100 may be arranged on the dielectric substrate 1020. The phased array antenna 1100 may include a plurality of patch antenna elements on a surface of the dielectric substrate. In this regard, the number of patch antenna elements is not limited to four, but may change to two, four, six, eight, ten, twelve, or sixteen depending on applications. The phased array antenna 1100 may transmit radio-frequency signals through the dielectric cover layer 1010 at a frequency between 10 GHz and 300 GHz. The phased array antenna 1100 may perform beamforming to change directions of beams by controlling phases of signals, which are applied to the plurality of patch antenna elements.

The first conductive layer 1151 may have a first aperture (opening) O1 and a second aperture O2 on a surface of the dielectric substrate 1020. The second conductive layer 1152 may have a third aperture O3 and a fourth aperture O4 on the surface of the dielectric substrate 1020.

A first antenna 1110 among the plurality of antenna elements may include a first patch element 1110a, ground traces 1110g, and a first transmission line path 1110b. The first patch element 1110a may be arranged on the surface of the dielectric substrate 1020. The ground traces 1110g may be embedded within the dielectric substrate 1020 and may be connected to a ground of the antenna module. The first transmission line path 1110b may be coupled to a first positive antenna feed F1 on the first patch element 1110a.

A second antenna 1120 among the plurality of antenna elements may include a second patch element 1120a, ground traces 1120g, and a second transmission line path 1120b. The second patch element 1120a may be arranged on the surface of the dielectric substrate 1020. The ground traces 1120g may be embedded within the dielectric substrate 1020 and may be connected to a ground of the antenna module. The second transmission line path 1120b may be coupled to a second positive antenna feed F2 on the second patch element 1120a.

Conductive vias inside the dielectric substrate 1020 may form one or more fences. The fences formed by the conductive vias may reduce unnecessary side radiation by the antenna elements, thereby forming stable array beams. The fences formed by the conductive vias may also increase the gain of forward beams by the antenna elements.

A first fence 1101 of the conductive vias within the dielectric substrate 1020 may be interposed between the first antenna 1110 and the second antenna 1120 and may be connected to the ground. The first fence 1101 of the conductive vias may be formed to extend to a first conductive surface 1101a, which is mounted opposite to the dielectric cover layer 1010.

The first patch element 1110a may be aligned with the first aperture O1, and the second patch element 1120a may be aligned with the second aperture O2. The first patch element 1110a and the second patch element 1120a may be arranged respectively inside the first aperture O1 and the second aperture O2 of the first conductive layer 1151. The first transmission line path 1110b may be aligned with the third aperture O3, and the second transmission line path 1120b may be aligned with the fourth aperture O4. The first transmission line path 1110b and the second transmission line path 1120b may be arranged respectively within the third aperture O3 and the fourth aperture O4 of the second conductive layer 1152.

A first gap G1 may be defined as a distance between the first patch element 1110a and an edge of the first aperture O1. A second gap G2 may be defined as a distance between the first transmission line path 1120a and the first fence 1101 of the conductive vias. A third gap G3 may be defined as a distance between the first transmission line path 1120a and an edge of the third aperture O3. The second gap G2 may be longer than the first gap G3. The third gap G3 may be longer than the first gap G1.

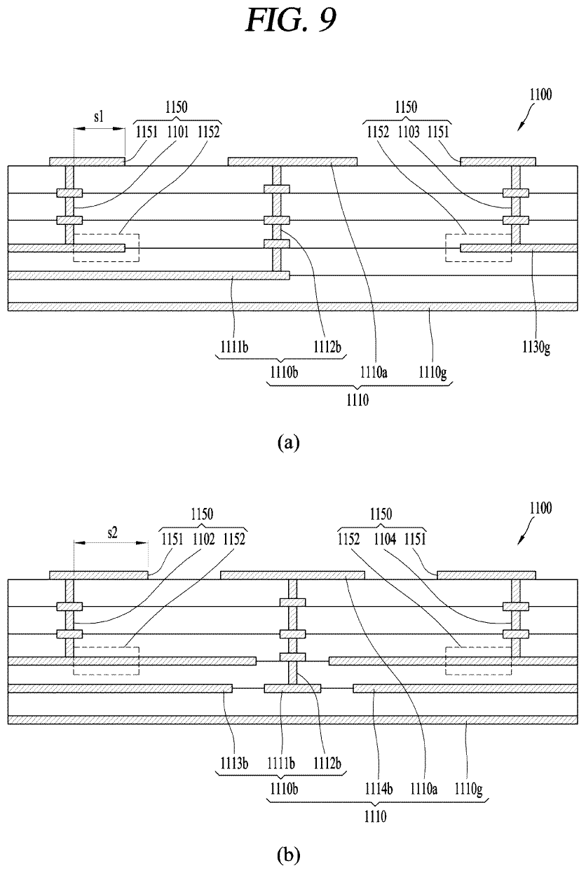

Hereinafter, the antenna module having the window wall structure will be described in detail. In the antenna module having the window wall structure according to the specification, the window wall structure may be formed in one axial direction and another axial direction. In this regard, FIG. 9 is a view of a structure in which window wall structures are formed on opposite sides of one antenna element of the antenna module of FIG. 7. (a) of FIG. 9 is a lateral view in a first axial direction of a structure in which window wall structures are formed on opposite sides of the antenna element of FIG. 7. (a) of FIG. 9 is a lateral view in a second axial direction of a structure in which window wall structures are formed on opposite sides of the antenna element of FIG. 7. The antenna element is not limited to a patch antenna element and may be applied to all types of antennas, which radiate radio waves on one surface of a printed circuit board (PCB), for example, a slot antenna or a dielectric resonator antenna (DRA).

Referring to (a) of FIG. 9, the patch element 1110a may be connected to a feed line 1111b through feed vias 1112b. The feed line 1111b and the feed vias 1112b may form the transmission line path 1110b. The feed line 1111b may be surrounded by grounds 1110g and 1130g above and below the feed line 1111b, or the ground 1110g may be present only on one surface of the feed line 1111b. The feed line 1111b may be formed in a strip line structure or a microstrip line structure with grounds formed above and below the feed line 1111b.

Referring to (a) of FIG. 9, a portion of the feed line 1111b connected to the feed vias 1112b may be formed in a microstrip line structure. Referring to (b) of FIG. 9, a portion of the feed line 1111b connected to the feed vias 1112b may be formed in a strip line structure. The strip line structure may form a CPW line structure in which ground patterns 1113b and 1114b are arranged on opposite sides of the feed line 1111b. Therefore, the strip line structure may be formed on the C-shaped window wall 1150.

Referring to FIGS. 7 to 9, the C-shaped window wall 1150 may include a plurality of conductive layers and a connection portion. The C-shaped window wall 1150 may include a first conductive layer 1151, a fence 1101 of conductive vias, and a second conductive layer 1153. The first conductive layer 1151 and the second conductive layer 1152 may form upper end and lower end of the C-shaped window wall 1150. Accordingly, the first conductive layer 1151 and the second conductive layer 1152 may be referred to as an upper window and a lower window (window grounds), respectively. The fence 1101 of the conductive vias which connects the first conductive layer 1151 and the second conductive layer 1152 may also be referred to as a window via.

The C-shaped window wall 1150 may be formed in one axial direction and another axial direction for each layer on which the conductive layer is formed. In this regard, the C-shaped window wall 1150 may include fences 1102 and 1104 of the conductive vias in one axial direction, and fences 1101 and 1103 of the conductive vias in another axial direction. The feed via 1112b may be connected to the patch element 1110a by being offset to one side or another side relative to the center of the patch element 1110a, but is not limited thereto. As another example, the feed via 1112b may be connected to the patch element 1110a by being offset upward or downward relative to the center of the patch element 1110a.

Since the positive antenna feeds F1 and F2 by the feed vias 1112b are arranged on opposite sides of the patch elements 1110a and 1120a, an electric field (E-field) of the array patch antenna may be generated in left and right directions and have horizontal polarization characteristics. The window wall 1150 in a direction perpendicular to the direction of the E-field may be formed in the another axial direction, namely, may correspond to the fences 1101 and 1103 of the conductive vias in the another axis direction. The window wall 1150 in a direction horizontal to the direction of the E-field may be formed in the one axial direction, namely, may correspond to the fences 1102 and 1104 of the conductive vias in the one axis direction. In this regard, even when the E-field is rotated by a certain angle, for example, 45 degrees, from the horizontal polarization, the window wall 1150 may be formed in the one axial direction and the another axial direction based on the corresponding angular direction.

The fences 1101 and 1103 of the conductive vias in the another axial direction may be located on opposite sides of the patch element 1110a and thus be arranged between the patch antennas upon being arrayed. A distance G1 from an edge of the patch element 1110a to the first fence 1101 of the conductive vias may be set to be longer than a distance G4 from the edge of the patch element 1110a to the second fence 1102 of the conductive vias. In some embodiment, the distance G1 from the edge of the patch element 1110a to the first fence 1101 of the conductive vias may be set to be longer than a distance G6 from the edge of the patch element 1110a to the second fence 1104 of the conductive vias. Accordingly, the antenna gain of the phased array antenna 1100 may be improved.

The fences 1102 and 1104 of the conductive vias in the one axial direction may be located above and below the patch element 1110a and closer to the edge of the patch element 1110a than the fences 1101 and 1103 of the conductive vias in the another axial direction. A distance G4 from the edge of the patch element 1110a to the second fence 1102 of the conductive vias may be set to be shorter than the distance G1 from the edge of the patch element 1110a to the first fence 1101 of the conductive vias. In some embodiment, the distance G4 from the edge of the patch element 1110a to the second fence 1102 of the conductive vias may be set to be shorter than a distance G5 from the edge of the patch element 1110a to the third fence 1103 of the conductive vias. This may result in suppressing the radiation performance of the phased array antenna 1100 in a side direction and increase the directivity in an upper direction.

In this regard, the distance G1 from the center of the patch element 1110a to the first fence 1101 of the conductive vias and the distance G2 from the center of the patch element 1110a to the second fence 1102 of the conductive vias may be designed within a range as in Mathematical Formula 1.

$$0.28 {λ}_{0} \leq g 1 \leq 0.36 {λ}_{0} \\ 0.16 {λ}_{0} \leq g 2 \leq 0.31 {λ}_{0} ( g 2 \leq g 1 ) \qquad [ Mathematical Formula 1 ]$$

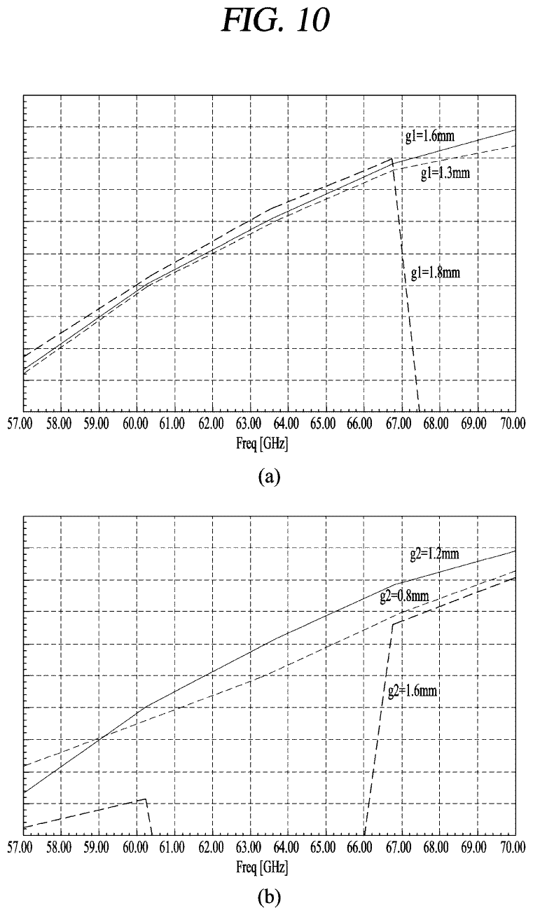

In this regard, FIG. 10 compares antenna gain characteristics according to changes in distances from the center of a patch element to first and second fences of conductive vias. (a) of FIG. 10 compares antenna gain characteristics according to the change of a distance g1 from the center of the patch element to the first fence of the conductive vias. (b) of FIG. 10 compares antenna gain characteristics according to the change of a distance g2 from the center of the patch element to the second fence of the conductive vias.

Referring to FIG. 10, since a center frequency is about 63 GHz in an operating bandwidth of 57 to 70 GHz, a wavelength in air may be about 4.8 mm based on the frequency of 63 GHz. Referring to (a) of FIG. 10, when the distance G1 to the first fence is 1.6 mm, the antenna gain characteristics may be satisfied. In this regard, when the distance g1 to the first fence G1 is 1.6 mm, this may correspond to 0.33 wavelength, satisfying the range of Mathematical Formula 1. However, the antenna gain characteristics may not be satisfied when the distance g1 to the first fence G1 is 1.3 mm and 1.8 mm. When the distance g1 to the first fence G1 is 1.6 mm, the antenna performance may be improved, compared to when the distance g1 is 1.3 mm. Meanwhile, when the distance g1 to the first fence G1 is 1.8 mm, it may be seen that the antenna gain performance is significantly distorted in a high frequency band.

Referring to (b) of FIG. 10, when the distance g2 to the second fence is 1.2 mm, the antenna gain characteristics may be satisfied. In this regard, when the distance g2 to the second fence G1 is 1.2 mm, this may correspond to 0.25 wavelength, satisfying the range of Mathematical Formula 1. However, the antenna gain characteristics may not be satisfied when the distance g2 to the second fence is 0.8 mm and 1.6 mm. When the distance g2 to the second fence is 1.2 mm, the antenna performance may be improved, compared to when the distance g2 is 0.8 mm. In some embodiments, when the distance g2 to the second fence G1 is 1.8 mm, it may be seen that the antenna gain performance is significantly distorted in a specific band of the high frequency band. Referring to FIGS. 7 to 10, the conductive vias forming the first to fourth fences 1101 to 1104 may be electrically connected to the ground 1110g and serve to improve the antenna gain. The first and second conductive layers 1151 and 1152 may form a window ground forming the window wall 1150. The first conductive layer 1151 may extend from the first positive antenna feed F1 by a first length s1. The second conductive layer 1152 may extend by a length which is longer than the length s1 of the first conductive layer 1151. Accordingly, when the feed line 1111b connected to the feed via 1112b has a microstrip line structure, an impedance distortion phenomenon caused by the first conductive layer 1151 may be suppressed by the second conductive layer 1152. Accordingly, stable antenna impedance performance may be secured.

As illustrated in (b) of FIG. 9, the feed line 1111b may have a strip line structure. The patch element 1110a may be fed by being offset only in one axial direction, and accordingly, the feed line 1111b and the feed via 1112b may be arranged with being offset only in the one axial direction, as illustrated in (a) of FIG. 9. Accordingly, as illustrated in (b) of FIG. 9, the feed line 1111b and the feed via 1112b may be formed at the center of the patch element 1110a in another axial direction.

An upper window, i.e., the first conductive layer 1151 constituting the C-shaped window wall 1150, may have a second length s2 in the another axial direction. The second length s2 of the first conductive layer 1151 forming the C-shaped window wall 1150 may be longer than the first length s1. Accordingly, the ground may be widely formed in the another axial direction, other than the one axial direction in which the antenna feed F1 is offset-formed, thereby further increasing the antenna gain.

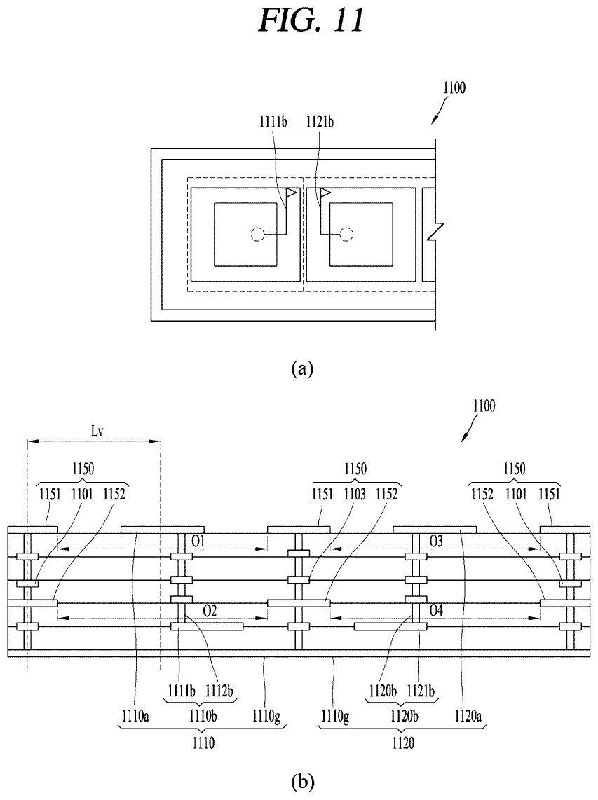

In some embodiments, in the antenna module having the window wall structure according to the specification, the C-shaped window wall 1150 may be formed to be connected to the ground. In this regard, FIG. 11 is a view of a structure in which window wall structures connected with a ground are formed on opposite sides of antenna elements of the antenna module of FIG. 7. (a) of FIG. 11 is a front view of a top layer of the phased array antenna 1100 having the window wall structure. (b) of FIG. 11 is a cross-sectional view of the phased array antenna 1100 of (a) of FIG. 11 in the one axial direction.

Referring to FIG. 11, the conductive vias corresponding to window vias may be formed to be connected to the ground 1110g. Accordingly, the second conductive layer 1152 below the first conductive layer 1151 may also be connected to the ground 1110g through the conductive vias 1101b. The feed lines 1111b and 1121b may be formed in a second axial direction in addition to a first axial direction. The feed lines 1111b and 1121b may extend in the right and left directions of the patch elements 1110a and 1120a on a lower layer. The feed lines 1111b and 1121b may be formed upward from the lower layer toward the patch elements 1110a and 1120a of the upper layer.

The first antenna 1110 may include a patch element 1110a, a feed line 1111a, and a feed via 1112b. The second antenna 1120 may include a patch element 1120b, a feed line 1121a, and a feed via 1122b. The first antenna 1110 and the second antenna 1120 may further include ground traces 1110g.

A window wall 1150 adjacent to the first antenna 1110 may include a first fence 1101 of conductive vias, a first conductive layer 1151, and a first conductive layer 1152. A window wall 1150 adjacent to the second antenna 1120 may include a third fence 1103 of conductive vias, a first conductive layer 1151, and a first conductive layer 1152. A third window wall 1150 adjacent to the second antenna 1120 may include a third fence 1103 of conductive vias, a first conductive layer 1151, and a first conductive layer 1152.

Reflection coefficient performance degradation may occur when a distance from the center of the patch element 1110a, 1120a to a window via is shorter than a first threshold. In some embodiments, parasitic radiation may occur when the distance from the center of the patch element 1110a, 1120a to the window via is longer than a second threshold. Therefore, a distance Lv from the center of the patch element 1110a, 1120a to the window via may be formed to satisfy the range of Mathematical Formula 2.

$$0.25 {λ}_{0} \leq Lv \leq 0.5 {λ}_{0} \qquad [ Mathematical Formula 2 ]$$

Referring to FIGS. 7 to 11, the first fence 1101 of the conductive vias and additional fences of conductive vias may be interposed between the first conductive layer 1151 and the first conductive layer 1152. The first fence 1101, the first conductive layer 1151, and the first conductive layer 1152 of the conductive vias may be arranged between the first and second antennas 1110 and 1120 to form a wall. The wall formed by the first fence 1101 of the conductive vias, the first conductive layer 1151, and the first conductive layer 1152 may include a first wall and a second wall. The first and second walls may oppose the first antenna 1110 and the second antenna 1120, respectively.

The first and second walls may be formed so that a conductive wall surrounding the patch antenna within a PCB formed as a multi-layered substrate has a C-shape rather than a linear shape. The conductive walls formed on the left and right sides of each antenna element may be formed to have the C-shape and have the same shape as the window of each antenna element. Accordingly, the conductive wall may also be referred to as a window wall. The window wall may include fences 1101 to 1104 of conductive vias.

In this regard, additional fences of conductive vias may be formed to surround a patch element. The additional fences of the conductive vias may include a second fence 1102 of conductive vias, a third fence 1103 of conductive vias, and a fourth fence 1104 of conductive vias. The first fence 1101 of the conductive vias may be formed to oppose the third fence 1103 of the conductive vias. The second fence 1102 of the conductive vias may be formed to oppose the fourth fence 1104 of the conductive vias. The second fence 1102 and the fourth fence 1104 of the conductive vias may be formed to be adjacent to the first fence 1101 of the conductive vias. The second fence 1102 and the fourth fence 1104 of the conductive vias may be formed to be adjacent to the third fence 1103 of the conductive vias.

The fences of the conductive vias corresponding to the window wall may be formed in the one axial direction and the another axial direction. The fences 1102 and 1104 of the conductive vias in the one axial direction may be arranged closer to the antenna element than the fences 1101 and 1103 of the conductive vias in the another axial direction. The fences 1102 and 1104 of the conductive vias in the one axial direction may reduce unnecessary side radiation and increase antenna directivity in the front direction. The fences 1101 and 1103 of the conductive vias in the another axial direction may increase the antenna directivity in the front direction, thereby improving the antenna gain.

Therefore, the C-shaped window wall structure formed by the fences of the conductive vias according to the specification may overcome two issues of the patch array antenna and simultaneously improve antenna performance. In this regard, in case of an array antenna capable of electrically steering beams, beams in various directions may have a form in which the gain is highest in the front direction and decreases toward the side regions. Therefore, the C-shaped window wall structure may reduce unnecessary side radiation of the patch array antenna, thereby forming a stable array beam.

In some embodiments, the C-shaped window wall structure may maximize the antenna beam gain in the front direction. In this regard, for an mmWave antenna array, high beam gain in the front direction needs to be implemented to compensate for propagation loss over distance. Accordingly, the mmWave antenna array must be implemented as an array antenna in which a plurality of antenna elements are arranged at a certain interval. However, when the number of antenna elements and the interval between the antenna elements increase, an overall antenna size may increase, making it difficult to arrange the antenna elements in a limited space. The C-shaped window wall structure according to the specification may maximize antenna beam gain while being limitedly arranged in a PCB without increasing the overall antenna size.

The first fence 1101 of the conductive vias and the additional fences of the conductive vias may be connected to the first conductive layer 1151 and the first conductive layer 1152. The first fence 1101 of the conductive vias and the additional fences of the conductive vias may include a set of conductive vias having a shape selected from a group consisting of square shapes. With respect to the group consisting of the square shapes, the shape of the aperture formed by the fences of the conductive vias may not be limited to the square shape, and may be formed in any polygonal shape or a circular shape corresponding to the shape of the patch antenna element.

A first gap G1 may be defined as a distance between a first edge of the first patch element 1110a and an edge of a first aperture O1 adjacent to the first fence 1101 of the conductive vias. A fourth gap G4 may be defined as a distance between a second edge of the first patch element 1110a and a second edge of the first aperture O1 adjacent to the second fence 1102 of the conductive vias. A distance of the first gap G1 may be longer than a distance of the fourth gap G4.

A fifth gap G5 may be defined as a distance between a third edge of the first patch element 1110a and a third edge of the first aperture O1 adjacent to the third fence 1103 of the conductive vias. The distance of the first gap G1 may be equal to the distance of the fifth gap G5 or similar to the distance of the fifth gap G5 within a certain range. A sixth gap G6 may be defined as a distance between a fourth edge of the first patch element 1110a and a fourth edge of the first aperture O1 adjacent to the fourth fence 1104 of the conductive vias. A distance of the fourth gap G4 may be equal to the distance of the sixth gap G6 or similar to the distance of the sixth gap G6 within a certain range.

The first transmission line path 1110b may be arranged adjacent to the first edge of the first aperture O1 which is adjacent to the first fence 1101 of the conductive vias. The second transmission line path 1120b may be arranged adjacent to the first edge of the second aperture O2 which is adjacent to the second fence 1102 of the conductive vias.

A seventh gap G7 may be defined as a distance between a first edge of the second patch element 1120 and a first edge of the second aperture O2. An eighth gap G8 may be defined as a distance between the second transmission line path 1120b and the first fence 1101 of the conductive vias. A ninth gap G9 may be defined as a distance between the second transmission line path 1120b and a first edge of the fourth aperture O4. A distance of the fifth gap G8 may be longer than a distance of the sixth gap G6. The distance of the sixth gap G6 may be longer than the distance of the fourth gap G4.

A plurality of antenna elements constituting the phased array antenna 1100 may include a plurality of antenna unit cells. Each antenna unit cell may include fences of conductive vias. The fences 1101 to 1104 of the conductive vias may extend from the first conductive layer 1152 to the first conductive layer 1151 through the dielectric substrate 1020. The fences 1101 to 1104 of the conductive vias, the first conductive layer 1151, and the first conductive layer 1152 may define (form) a cavity.

The dielectric cover layer 1010 may be formed to have a thickness and dielectric constant that constitute the dielectric cover layer 1010 to form a quarter wave impedance transformer between the phased array antennas.

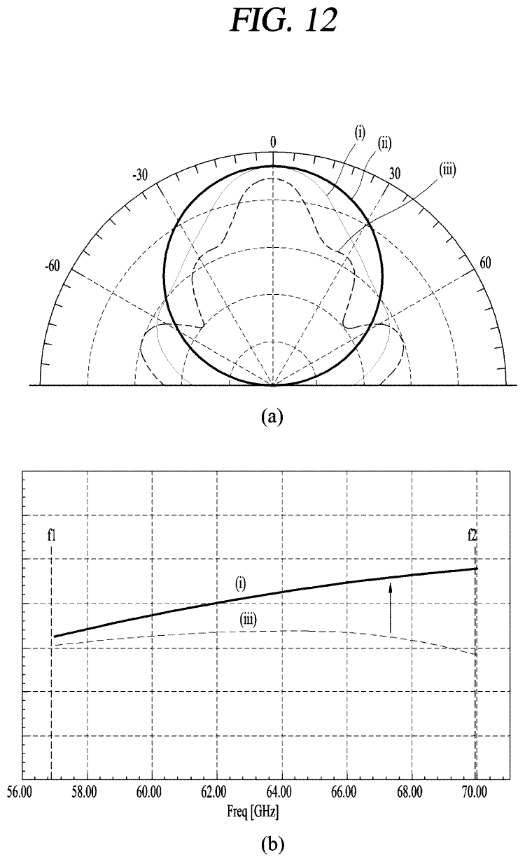

Hereinafter, a description will be given by comparing radiation characteristics and antenna gain characteristics of an antenna module having the C-shaped window wall 1150 according to the disclosure with those of a structure without a window wall. In this regard, FIG. 12 compares radiation characteristics and antenna gain characteristics of an antenna module having a C-shaped window wall according to the disclosure with those of a structure without a window wall. (a) of FIG. 12 shows the antenna radiation characteristics depending on presence or absence of a window wall. (b) of FIG. 12 shows the antenna gain characteristics depending on presence or absence of a window wall.

(i) and (ii) of (a) of FIG. 12 show E-plane radiation pattern and H-plane radiation pattern of a structure having a window wall. (iii) of (a) of FIG. 12 shows an E-plane radiation pattern of a structure without a window wall. In this regard, the E-plane radiation pattern and the H-plane radiation pattern may represent a radiation pattern in one axial direction corresponding to a feeding direction and a radiation pattern in another axial direction perpendicular to the one axial direction, respectively.

It may be seen from the array antenna beam envelope graph of (a) of FIG. 12 that the side radiation is reduced when the window wall is applied. Accordingly, the directivity in the front direction from the patch antenna may be improved through the window wall structure. Comparing the E-plane radiation patterns of (a) of FIG. 12, the envelope of a radiation pattern obtained by synthesizing a plurality of beams (e.g., 35 beams) into one is shown. It may be seen that a large amount of beams is radiated in the side direction in case of absence of a window wall, whereas a beam pattern with the window wall structure is reduced in the side region and the antenna gain directed toward the front is increased. The radiation pattern on the H-plane may form an elliptical radiation pattern without distortion, such as warping or tilting, thereby improving a peak gain while maintaining a stable mmWave beam pattern.

(i) and (iii) in (b) of FIG. 12 show a gain value in an E-plane of a first structure with the window wall and a gain value in an E-plane of a second structure without a window wall, respectively. Referring to (i) and (iii) in (b) of FIG. 12, it may be seen that the maximum antenna gain directed toward the front is improved in the first structure having the window wall. When the lowest frequency in an operating frequency band is f1 and the highest frequency is f2, then f1=57 GHz and f2=70 GHz. It may be seen that the maximum antenna gain performance directed toward the front has been improved in all frequency bands within f1 and f2.

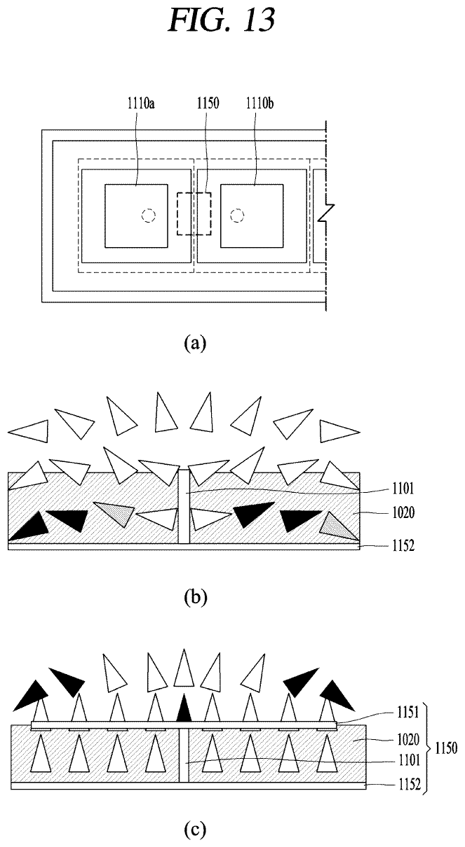

A phased array antenna having a window wall formed according to the specification may control phases of signals applied to a plurality of antenna elements to perform beamforming in an mmWave band. In this regard, FIG. 13 is a view of a structure, in which a window wall is formed between antenna elements of a phased array antenna according to the disclosure, and electric field distribution depending on presence or absence of the window wall. During beamforming, the direction of beams may be steered by inputting signals with different phases to the antennas.

Referring to (a) of FIG. 13, the window wall 1150 may be formed between the patch elements 1110a and 1120a. (b) and (c) of FIG. 13 show electric field distributions in case where a window wall is formed and a case where a window wall is not formed. (b) of FIG. 13 shows a first structure in which the second conductor 1152, which may be connected to the ground, is connected to the conductive via 1101. (c) of FIG. 13 shows a second structure in which the second conductor 1152, which may be connected to the ground, is connected to the fence 1101 of the conductive vias and the first conductor 1151. In the second structure of (c) of FIG. 13, the first conductor 1151, the fence 1101 of the conducive vias, and the second conductor 1152 may form the window wall structure 1150.

Referring to (b) of FIG. 13, when there is no window wall and phase values are applied to two different antennas with a 90 degree difference, the E-field distribution between the antennas is shown. In case of the absence of a window, the direction of the E-field inside the dielectric substrate 1020 may be formed left and right in the E-field distribution. Therefore, the E-Field radiated in the upper direction of the dielectric substrate 1020 may not be maintained in shape and may be dispersed in various directions.

When the E-field is dispersed in different directions or the direction of the E-field is different from a desired direction, synthesized antenna beams may cancel each other or may be formed in an undesired direction. Accordingly, sidelobes or surface waves of the antenna beams may be induced, thereby increasing beams in the side direction.

Referring to (a) and (c) of FIG. 13, when the window wall 1150 is formed, the E-field in the dielectric substrate 1020 may be distributed in the upper direction by the window wall 1150. Accordingly, all E-fields within the dielectric substrate 1020 may be directed in the same direction. The direction of the E-field may move upward/downward over time, and the components of the E-field directed left and right may decrease. Accordingly, the shape of the E-field radiating toward the upper portion of the dielectric substrate 1020 may be maintained and the E-field may not be dispersed in the left and right directions. This may allow E-field components in the same direction to be obtained in the inner and upper regions of the dielectric substrate 1020, such that the antenna beams may be synthesized in a desired direction, namely, in a main lobe direction. Therefore, by this antenna operating principle, the window wall may induce the synthesis of beams of the antenna, thereby increasing the antenna gain and reducing unnecessary radiation in the side direction.

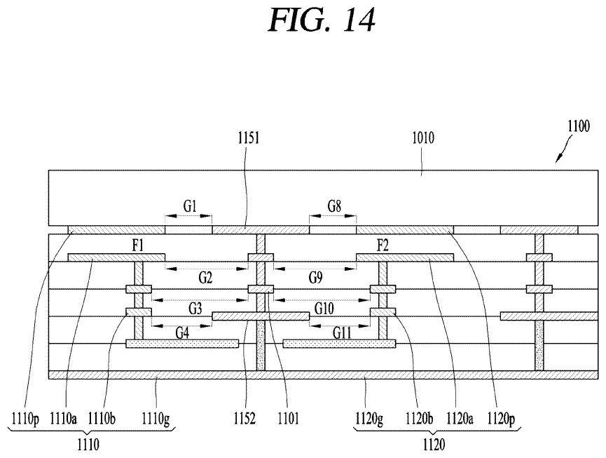

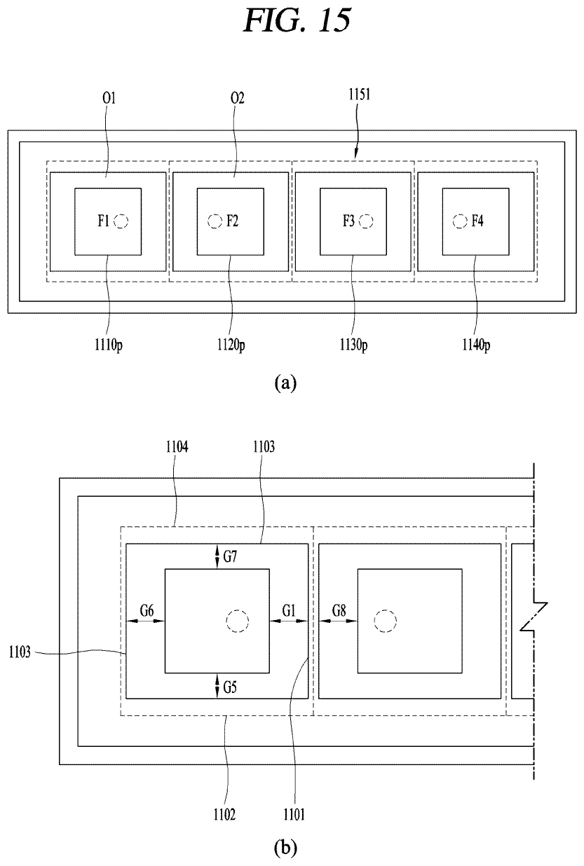

Hereinafter, an antenna module operating in a millimeter wave band and an electronic device including the same according to another aspect of the disclosure will be described. In this regard, FIG. 14 is a lateral view of an antenna module operating in a millimeter wave band according to another aspect of the disclosure. FIG. 15 is a front view of the antenna module of FIG. 14. In relation to this, the antenna module of FIG. 14 has a difference of configuration from the antenna module of FIG. 7 in that a parasitic patch element is arranged on top of a patch element. The parasitic patch element may also be referred to as a coupling patch element because it is coupled to the patch element.

Referring to FIG. 14, a first antenna 1110 may be configured such that a first parasitic patch element 1110p is arranged on top of a first patch element 1110a. A second antenna 1120 may be configured such that a second parasitic patch element 1120p is arranged on top of a second patch element 1120a. The first and second parasitic patch elements 1110p and 1120p may be arranged on top of the first and second patch elements 1110a and 1120a to enable a broadband operation. A first length of the first and second parasitic patch elements 1110p and 1120p may be different from a second length of the first and second patch elements 1110a and 1120a. Accordingly, the second radiation structure of FIG. 14 may operate in a wider band than the first radiation structure of FIG. 7.

(a) of FIG. 15 is a front view of the parasitic patch elements 1110p to 1140p surrounded by a conductive layer 1151. (b) of FIG. 15 is an enlarged view of (a) of FIG. 15, which is front view of the first parasitic patch element 1110p surrounded by fences 1101 to 1104 of conductive vias.

Referring to FIGS. 14 and 15, the electronic device may include an antenna module. The antenna module may include a dielectric cover layer 1010, a dielectric substrate 1020, and a phased array antenna 1110. The antenna module may further include a first conductive layer 1151 and a first conductive layer 1152.

The dielectric cover layer 1010 may be arranged in an upper region of the dielectric substrate 1020. The dielectric cover layer 1010 may be formed as a dielectric structure of the electronic device and may act as a cover or radome to suppress the phased array antenna 1100 from being exposed to the outside. The dielectric substrate 1020 may be formed to have a surface which is mounted to oppose the dielectric cover layer 1010.

The phased array antenna 1100 may be arranged on the dielectric substrate 1020. The phased array antenna 1100 may include a plurality of patch antenna elements on a surface of the dielectric substrate. In this regard, the number of patch antenna elements is not limited to four, but may change to two, four, six, eight, ten, twelve, or sixteen depending on applications. The phased array antenna 1100 may transmit radio-frequency signals through the dielectric cover layer 1010 at a frequency between 10 GHz and 300 GHz. The phased array antenna 1100 may perform beamforming to change directions of beams by controlling phases of signals, which are applied to the plurality of patch antenna elements.

The first conductive layer 1151 may have a first aperture O1 and a second aperture O2 on a surface of the dielectric substrate 1020. The first conductive layer 1152 may have a third aperture O3 and a fourth aperture O4 on the surface of the dielectric substrate 1020.

A first antenna 1110 among the plurality of antenna elements may include a first parasitic patch element 1110p, a first patch element 1110a, ground traces 1110g, and a first transmission line path 1110b. The first parasitic patch element 1110p may be arranged on a surface of the dielectric substrate 1020 for the first antenna 1110. The first patch element 1110a may be arranged in the dielectric substrate 1020. The ground traces 1110g may be embedded within the dielectric substrate 1020 and may be connected to a ground of the antenna module. The first transmission line path 1110b may be coupled to a first positive antenna feed F1 on the first patch element 1110a.

A second antenna 1120 among the plurality of antenna elements may include a second parasitic patch element 1120p, a second patch element 1120a, ground traces 1120g, and a second transmission line path 1120b. The first parasitic patch element 1120p may be arranged on a surface of the dielectric substrate 1020 for the second antenna 1120. The second patch element 1120a may be arranged in the dielectric substrate 1020. The ground traces 1120g may be embedded within the dielectric substrate 1020 and may be connected to a ground of the antenna module. The second transmission line path 1120b may be coupled to a second positive antenna feed F2 on the second patch element 1120a.

Conductive vias inside the dielectric substrate 1020 may form one or more fences. The fences formed by the conductive vias may reduce unnecessary side radiation by the antenna elements, thereby forming stable array beams. The fences formed by the conductive vias may also increase the gain of forward beams by the antenna elements.

A first fence 1101 of conductive vias within the dielectric substrate 1020 may be interposed between the first antenna 1110 and the second antenna 1120 and may be connected to the ground. The first fence 1101 of the conductive vias may be formed to extend to a first conductive surface 1101a, which is mounted opposite to the dielectric cover layer 1010.

The first patch element 1110a may be aligned with the first aperture O1, and the second patch element 1120a may be aligned with the second aperture O2. The first patch element 1110a and the second patch element 1120a may be arranged respectively inside the first aperture O1 and the second aperture O2 of the first conductive layer 1151. The first transmission line path 1110b may be aligned with the third aperture O3, and the second transmission line path 1120b may be aligned with the fourth aperture O4. The first transmission line path 1110b and the second transmission line path 1120b may be arranged respectively within the third aperture O3 and the fourth aperture O4 of the second conductive layer 1152.

A first gap G1 may be defined as a distance between the first parasitic patch element 1110p and an edge of the first aperture O1. A second gap G2 may be defined as a distance between the first patch element 1110a and an edge of the first aperture O1. A third gap G3 may be defined as a distance between the first transmission line path 1120a and the first fence 1101 of the conductive vias. A fourth gap G4 may be defined as a distance between the first transmission line path 1120a and an edge of the third aperture O3. A distance of the third gap G3 may be longer than a distance of the second gap G2. The second gap G2 may be longer than the first gap G1. A distance of the third gap G3 may be longer than the distance of the fourth gap G4.

In some embodiments, as described in the antenna structure of FIG. 7, the first fence 1101 of the conductive vias and additional fences of the conductive vias may be interposed between the first conductive layer 1151 and the first conductive layer 1152. The additional fences of the conductive vias may be formed to surround the patch element. The additional fences of the conductive vias may include a second fence 1102 of conductive vias, a third fence 1103 of conductive vias, and a fourth fence 1104 of conductive vias. The first fence 1101 of the conductive vias may be formed to oppose the third fence 1103 of the conductive vias. The second fence 1102 of the conductive vias may be formed to oppose the fourth fence 1104 of the conductive vias. The second fence 1102 and the fourth fence 1104 of the conductive vias may be formed to be adjacent to the first fence 1101 of the conductive vias. The second fence 1102 and the fourth fence 1104 of the conductive vias may be formed to be adjacent to the third fence 1103 of the conductive vias.

The first fence 1101 of the conductive vias and the additional fences of the conductive vias may be connected to the first conductive layer 1151 and the first conductive layer 1152. The first fence 1101 of the conductive vias and the additional fences of the conductive vias may include a set of conductive vias having a shape selected from a group consisting of square shapes. With respect to the group consisting of the square shapes, the shape of the aperture formed by the fences of the conductive vias may not be limited to the square shape, and may be formed in any polygonal shape or a circular shape corresponding to the shape of the patch antenna element.

A first gap G1 may be defined as a distance between a first edge of the first parasitic patch element 1110p and an edge of a first aperture O1 adjacent to the first fence 1101 of the conductive vias. A fifth gap G5 may be defined as a distance between a second edge of the first parasitic patch element 1110p and a second edge of the first aperture O1 adjacent to the second fence 1102 of the conductive vias. A distance of the first gap G1 may be longer than a distance of the fifth gap G5.

A sixth gap G6 may be defined as a distance between a third edge of the first parasitic patch element 1110p and a third edge of the first aperture O1 adjacent to the third fence 1103 of the conductive vias. The distance of the first gap G1 may be equal to the distance of the sixth gap G6 or similar to the distance of the sixth gap G6 within a certain range. A seventh gap G7 may be defined as a distance between a fourth edge of the first parasitic patch element 1110p and a fourth edge of the first aperture O1 adjacent to the fourth fence 1104 of the conductive vias. A distance of the fifth gap G5 may be equal to a distance of the seventh gap G7 or similar to the distance of the seventh gap G7 within a certain range.

The first transmission line path 1110b may be arranged adjacent to the first edge of the first aperture O1 which is adjacent to the first fence 1101 of the conductive vias. The second transmission line path 1120b may be arranged adjacent to the first edge of the second aperture O2 which is adjacent to the second fence 1102 of the conductive vias.

An eighth gap G8 may be defined as a distance between a first edge of the second parasitic patch element 1120p and a first edge of the second aperture O2. A ninth gap G9 may be defined as a distance between a first edge of the second patch element 1120a and a first edge of the second aperture O2. A tenth gap G10 may be defined as a distance between the second transmission line path 1120b and the first fence 1101 of the conductive vias. An eleventh gap G11 may be defined as a distance between the second transmission line path 1120b and a first edge of the fourth aperture O4. A distance of the tenth gap G10 may be longer than a distance of the ninth gap G9. The distance of the ninth gap G9 may be longer than a distance of the eighth gap G8. The distance of the tenth gap G10 may be longer than a distance of the tenth gap G11.

A plurality of antenna elements constituting the phased array antenna 1100 may include a plurality of antenna unit cells. Each antenna unit cell may include fences of conductive vias. The fences 1101 to 1104 of the conductive vias may extend from the first conductive layer 1152 to the first conductive layer 1151 through the dielectric substrate 1020. The fences 1101 to 1104 of the conductive vias, the first conductive layer 1151, and the first conductive layer 1152 may define (form) a cavity.

The dielectric cover layer 1010 may be formed to have a thickness and dielectric constant that constitute the dielectric cover layer 1010 to form a quarter wave impedance transformer between the phased array antennas.

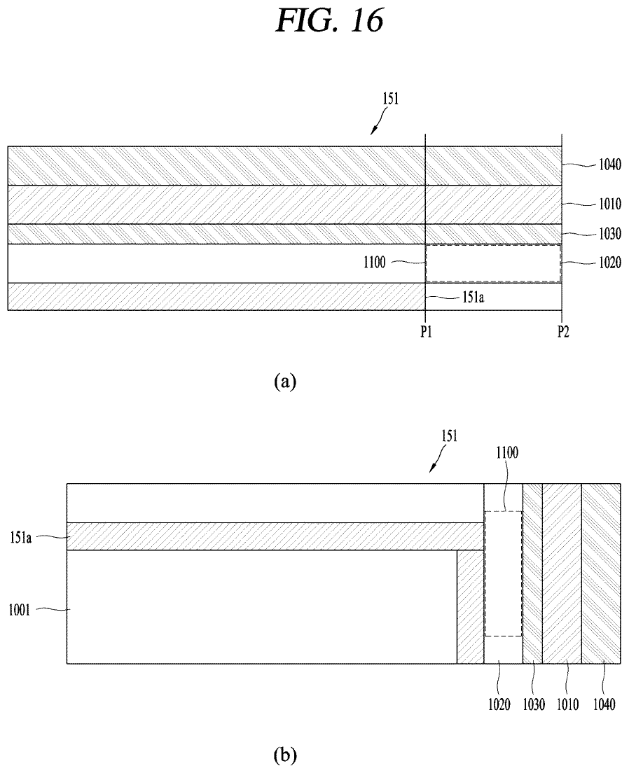

The structural features of an antenna module (phased array antenna) operating in the mmWave band according to the disclosure have been described above. Hereinafter, a description will be given in detail of a stacked structure, in which a patch element of a phased array antenna, a dielectric substrate, and a dielectric cover layer, and electrical characteristics of the stacked structure according to the disclosure. In this regard, FIG. 16 is a view of a structure in which a dielectric substrate, on which a phased array antenna is formed, is coupled with a dielectric cover layer and a display.

(a) of FIG. 16 is a view of a structure in which an antenna module 1100 formed as a phased array antenna is arranged on a front surface of an electronic device 1000. In some embodiments, a structure is illustrated in which the antenna module 1100 is arranged below the display 151, which is formed on a front side of the electronic device. Referring to (a) of FIG. 16, a pixel circuit 151a may be formed up to a first point R1. Accordingly, an area where information is displayed on the display 151 may be formed up to the first point R1, and a bezel area may be formed from the first point R1 to a second point R2. As another example, the pixel circuit 151a may be formed to an end of the electronic device 1000 to implement a full display. Accordingly, an area where information is displayed on the display 151 may be formed up to the second point R1, thereby implementing a bezel-less full display.

(b) of FIG. 16 is a view of a structure in which the antenna module 1100 formed as the phased array antenna is arranged on a side surface of the electronic device 1000. A dielectric cover layer 1010 may be formed on a dielectric substrate 1020, on which the antenna module 1100 is formed, so that the antenna module 1100 may be protected from an external environment. For example, a display cover 1040 may be formed on the dielectric cover layer 1010. Accordingly, the electronic device 1000 may have a full display formed on the front and side surfaces. For this purpose, the pixel circuit 151a may also be formed on the side surface. The antenna module 1100 may be arranged in a case 1001 of the electronic device or in a case separate from the case 1001.

Referring to FIGS. 7 to 16, the first patch element 1110a and the second patch element 1120a may be formed to be in direct contact with the surface of the dielectric cover layer 1010. In this regard, the stacked structure of FIG. 16 is illustrated based on the antenna structure of FIG. 7, but is not limited thereto. The stacked structure of FIG. 16 may also be applied to the antenna structure of FIG. 13. In some embodiments, the first parasitic patch element 1110p and the second patch element 1120p may be formed to be in direct contact with a surface of the dielectric cover layer 1010.

The antenna module may further include an adhesive layer 1030 by which the dielectric substrate 1020 is attached to the dielectric cover layer 1010. The first patch element 1110a and the second patch element 1120a may be formed to be in direct contact with the adhesive layer 1030. In this regard, the stacked structure of FIG. 16 is illustrated based on the antenna structure of FIG. 7, but is not limited thereto. The stacked structure of FIG. 16 may also be applied to the antenna structure of FIG. 13. In some embodiments, the first parasitic patch element 1110p and the second patch element 1120p may be formed to be in direct contact with the adhesive layer 1030.

The dielectric cover layer 1010 may be configured to have a first dielectric constant. For example, the dielectric cover layer 1010 may be configured to have a dielectric constant between 3.0 and 10.0. In some embodiments, the adhesive layer 1030 may be configured to have a second dielectric constant which is lower than the first dielectric constant. In this regard, antenna efficiency may be improved by lowering the dielectric constant of the adhesive layer 1030 which is in direct contact with the first patch element 1110a and the second patch element 1120a. In some embodiments, antenna directivity (gain) may be improved by increasing the dielectric constant of the dielectric cover layer 1010, which is spaced apart from the first patch element 1110a and the second patch element 1120a by at least certain distances.

The phased array antenna 1100 may be configured to radiate radio frequency signals at an operating frequency. Radio frequency signals of the operating frequency may be formed to exhibit an effective wavelength while propagating through the dielectric cover layer 1010. The dielectric cover layer 1010 may have a thickness which is 0.15 to 0.3 times the effective wavelength. The thickness of the dielectric cover layer 1010 may be set to a value in a certain range based on 0.25 times the effective wavelength, namely, ¼ wavelength of the effective wavelength. Accordingly, antenna directivity (gain) may be improved by increasing the dielectric constant of the dielectric cover layer 1010, which is spaced apart from the first patch element 1110a and the second patch element 1120a by at least certain distances.

The electronic device may further include a display 151 having a pixel circuit 151a. The display 151 may form a first surface, which is the front surface of the electronic device. The display 151 may include a first surface and a second surface. Accordingly, the display 151 may be formed on the front surface of the electronic device and, in some cases, may also be formed on the side surface of the electronic device. The display 151 may include a pixel circuit 151a which emits light through the display cover layer 1040 and the dielectric cover layer 1010. The display cover layer 1040 may form the first surface of the electronic device, and the dielectric cover layer 1010 may be formed adjacent to the display cover layer 1040.

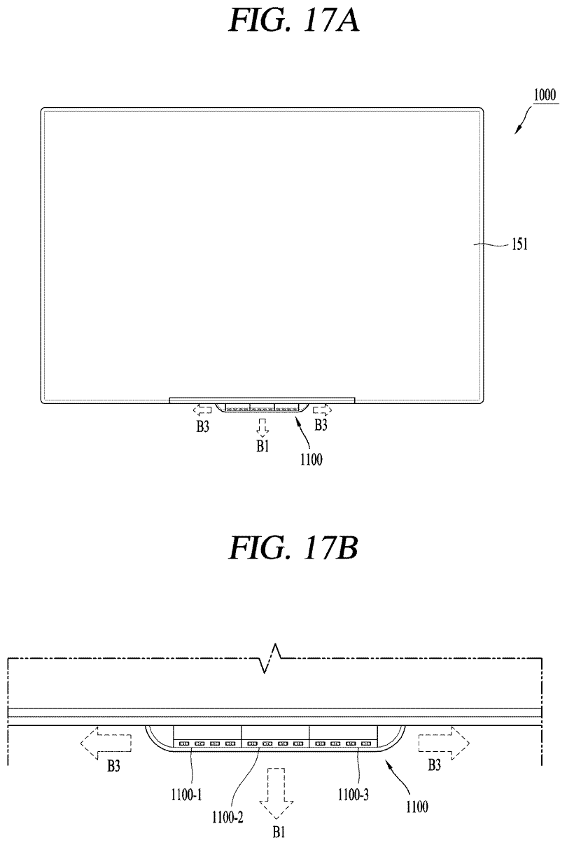

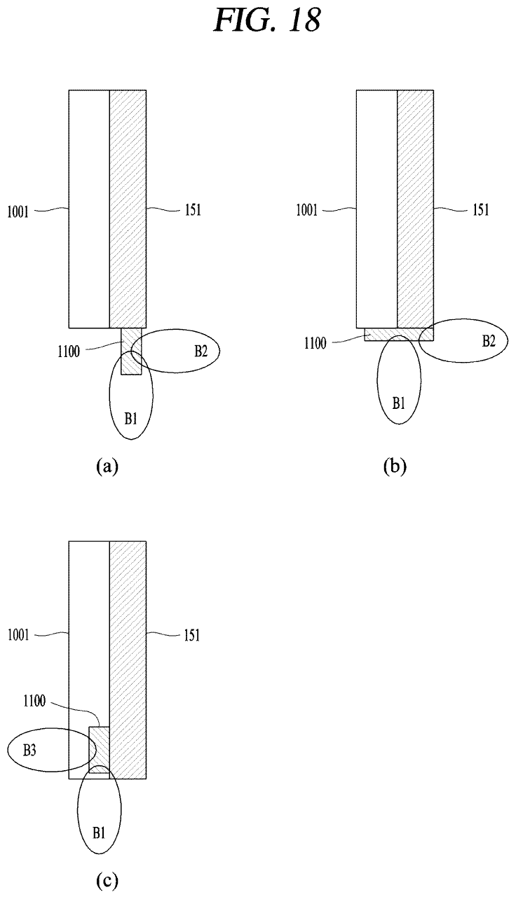

The antenna module disclosed herein may be configured as an array antenna. In this regard, FIG. 17A is a view of a structure in which the antenna module 1100 having a first type antenna and a second type antenna as array antennas is arranged on the electronic device 1000. FIG. 18B is an enlarged view of a plurality of array antenna modules. FIG. 17A and FIG. 17B are views of a structure in which the antenna module 1100 corresponding to the phased array antenna is formed on a side surface of a lower portion of the electronic device 1000. The antenna module 1100 of FIGS. 17A and 17B may have the structure, in which the antenna module 1100 is arranged on the side surface of the lower portion of the display 151 of (b) of FIG. 16.

Referring to FIGS. 1 to 17B, the array antenna may include a first array antenna module 1100-1, and a second array antenna module 1100-2 spaced apart from the first array antenna module 1100-1 by a certain gap in a first horizontal direction. In some embodiments, the number of array antennas is not limited to two, but may be at least three as illustrated in FIG. 18B. Therefore, the array antenna may include a first array antenna module 1100-1 to a third array antenna module 1100-3. As one example, at least one of the first array antenna module 1100-1, the second array antenna module 1100-2, or the third array antenna module 1100-3 may be arranged on a side surface of the antenna module 1100 and thus form a beam in a side direction.

As another example, at least one of the first array antenna module 1100-1, the second array antenna module 1100-2, or the third array antenna module 1100-3 may be disposed on a front surface of the antenna module 1100 and thus form a beam in a front direction. For example, the first array antenna module 1100-1 and the second array antenna module 1100-2 may form a first beam and a second beam in the front direction B1. The processor 1400 corresponding to the modem of FIG. 5C may control the first array antenna module 1100-1 and the second array antenna module 1100-2 to form the first beam and the second beam in a first direction and a second direction, respectively. For example, the processor 1400 may control the first array antenna module 1100-1 to form the first beam horizontally in the first direction. Also, the processor 1400 may control the second array antenna module 1100-2 to form the second beam horizontally in the second direction. In this regard, the processor 1400 may perform MIMO using the first beam of the first direction and the second beam of the second direction.

The processor 1400 corresponding to the modem of FIG. 5C may control the first array antenna module 1100-1 and the second array antenna module 1100-2 to form the first beam and the second beam in the first direction and the second direction, respectively. For example, the processor 1400 may control the first array antenna module 1100-1 to form the first beam horizontally in the first direction. Also, the processor 1400 may control the second array antenna module 1100-2 to form the second beam horizontally in the second direction. In this regard, the processor 1400 may perform MIMO using the first beam of the first direction and the second beam of the second direction.

The processor 1400 may form a third beam in a third direction using the first and second array antenna modules 1100-1 and 1100-2. In this regard, the processor 1400 may control the transceiver circuit 1250 to synthesize signals received through the first and second array antenna modules 1100-1 and 1100-2. Also, the processor 1400 may control the transceiver circuit 1250 to distribute signals transmitted to the first and second array antenna modules 1100-1 and 1100-2 into each antenna element. The processor 1400 may perform beamforming using the third beam which has a beam width narrower than those of the first beam and the second beam.

In some embodiments, the processor 1400 may perform MIMO using the first beam of the first direction and the second beam of the second direction, and perform beamforming using the third beam having the narrower beam width than those of the first beam and the second beam. In relation to this, when a first signal and a second signal received from other electronic devices in the vicinity of the electronic device have qualities lower than or equal to a threshold value, the processor 1400 may perform beamforming using the third beam.

The number of elements of the array antenna may be two, three, four, and the like as illustrated, but is not limited thereto. For example, the number of elements of the array antenna may be expanded to two, four, eight, sixteen, and the like. Therefore, the array antenna may be configured as 1×2, 1×3, 1×4, 1×5, . . . , 1×8 array antenna.

FIG. 18 is a view of an antenna module coupled in a different coupling structure at a specific position of an electronic device according to embodiments. Referring to (a) of FIG. 18, the antenna module 1100 may be arranged in the lower region of the display 151 to be substantially horizontal to the display 151. Accordingly, a beam B1 may be generated in a lower direction of the electronic device through the antenna module 1100. In some embodiments, another beam B2 may be generated in a front direction of the electronic device through a patch antenna. The antenna module 1100 of (a) of FIG. 18 may have the structure in which the antenna module 1100 is arranged on the lower portion of the front surface of the display 151 in (a) of FIG. 16.

Referring to (b) of FIG. 18, the antenna module 1100 may be arranged in the lower region of the display 151 to be substantially perpendicular to the display 151. Accordingly, a beam B2 may be generated in the front direction of the electronic device through the antenna module 1100. In some embodiments, another beam B1 may be generated in the lower direction of the electronic device through the patch antenna. The antenna module 1100 of (b) of FIG. 18 may have the structure in which the antenna module 1100 is arranged on the side surface of the lower portion of the display 151 in (a) of FIG. 16.

Referring to (c) of FIG. 18, the antenna module 1100 may be arranged, for example, inside a rear case 1001 corresponding to a mechanism structure. The antenna module 1100 may be arranged inside the rear case 1001 to be substantially parallel to the display 151. Accordingly, a beam B2 may be generated in the lower direction of the electronic device through a monopole radiator. In some embodiments, another beam B3 may be generated in a rear direction of the electronic device through a patch antenna.

So far, the broadband antenna module operating in the millimeter wave (mmWave) band and the electronic device having the same have been described. Hereinafter, technical effects of a broadband antenna module operating in a millimeter wave (mmWave) band and an electronic device having the same will be described.

Hereinafter, technical effects of a antenna module operating in a millimeter wave (mmWave) band and an electronic device having the same will be described.

According to an embodiment, antenna efficiency may be improved through a window wall structure, which is formed between antenna elements in a broadband antenna module operating in a millimeter wave (mmWave) band.

According to an embodiment, a window wall structure, which is formed between antenna elements in a broadband antenna module operating in an mmWave band, may be formed as a via structure on a multi-layered substrate, thereby improving antenna efficiency.

According to an embodiment, a window wall structure may suppress side radiation components, thereby improving efficiency and directivity in a front direction of an antenna element operating in an mmWave band.

According to an embodiment, an antenna structure, which achieves high antenna efficiency while operating as a broadband antenna for providing a broadband service in an mmWave band, may be provided through a stacked antenna structure and a window wall structure.

Further scope of applicability of the disclosure will become apparent from the following detailed description. It should be understood, however, that the detailed description and specific examples, such as the preferred embodiments, are given by way of illustration only, because various changes and modifications within the technical idea and scope of the disclosure will be apparent to those skilled in the art. In relation to the aforementioned disclosure, design and operations of an antenna operating in an mmWave band and an electronic device controlling the same may be implemented as computer-readable codes in a program-recorded medium.

The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller of the terminal. Therefore, the detailed description should not be limitedly construed in all of the aspects, and should be understood to be illustrative. Therefore, all changes and modifications that fall within the metes and bounds of the claims, or equivalents of such metes and bounds are therefore intended to be embraced by the appended claims.

1. An antenna module comprising:
a dielectric cover layer;
a dielectric substrate having a surface mounted to oppose the dielectric cover layer; and
a first conductive layer having a first aperture and a second aperture on the surface of the dielectric substrate;
a second conductive layer having a third aperture and a fourth aperture inside the dielectric substrate; and
a phased array antenna arranged on the dielectric substrate,
wherein the phased array antenna comprises a plurality of patch antenna elements on the surface of the dielectric substrate,
the phased array antenna is configured to transmit radio-frequency signals at a frequency between 10 GHz and 300 GHz through the dielectric cover layer,
a first antenna of the plurality of patch antenna elements comprises a first patch element on the surface of the dielectric substrate, ground traces embedded in the dielectric substrate, and a first transmission line path coupled to a first positive antenna feed on the first patch element,
a second antenna of the plurality of patch antenna elements comprises a second patch element on the surface of the dielectric substrate, ground traces embedded in the dielectric substrate, and a second transmission line path coupled to a second positive antenna feed on the second patch element,
a first fence of conductive vias in the dielectric substrate is interposed between the first antenna and the second antenna and is connected to a ground,
the first fence of the conductive vias extends to a first conductive surface mounted to oppose the dielectric cover layer,
the first patch element is aligned with the first aperture, the second patch element is aligned with the second aperture, the first transmission line path is aligned with the third aperture, and the second transmission line path is aligned with the fourth aperture,
a first gap is a distance between the first patch element and an edge of the first aperture, a second gap is a distance between the first transmission line path and the first fence of the conductive vias, and a third gap is a distance between the first transmission line path and an edge of the third aperture, and
a distance of the second gap is longer than a distance of the third gap, and the distance of the third gap is longer than a distance of the first gap.

2. The antenna module of claim 1, wherein the first fence of the conductive vias and additional fences of conductive vias are interposed between the first conductive layer and the second conductive layer, and
the first fence of the conductive vias and the additional fences of the conductive vias are connected to the first conductive layer and the second conductive layer.

3. The antenna module of claim 2, wherein the first fence of the conductive vias and the additional fences of the conductive vias comprise a set of conductive vias having a shape selected from a group consisting of square shapes.

4. The antenna module of claim 3, wherein the additional fences of the conductive vias comprise a second fence of conductive vias, a third fence of conductive vias, and a fourth fence of conductive vias,
the first fence of the conductive vias opposes the third fence of the conductive vias, and
the second fence of the conductive vias opposes the fourth fence of the conductive vias.

5. The antenna module of claim 4, wherein the second fence of the conductive vias is arranged adjacent to the first fence of the conductive vias,
the first gap is a distance between a first edge of the first patch element and a first edge of the first aperture adjacent to the first fence of the conductive vias,
a fourth gap is a distance between a second edge of the first patch element and a second edge of the first aperture adjacent to the second fence of the conductive vias, and
a distance of the first gap is longer than a distance of the fourth gap.

6. The antenna module of claim 4, wherein the first fence of the conductive vias opposes the third fence of the conductive vias, and
a fifth gap is a distance between a third edge of the first patch element and a third edge of the first aperture adjacent to the second fence of the conductive vias, and
a distance of the first gap is equal or similar to a distance of the fifth gap.

7. The antenna module of claim 5, wherein the second fence of the conductive vias opposes the fourth fence of the conductive vias,
a sixth gap is a distance between a fourth edge of the first patch element and a fourth edge of the first aperture adjacent to the fourth fence of the conductive vias, and
a distance of the fourth gap is equal or similar to a distance of the sixth gap.

8. The antenna module of claim 5, wherein the first transmission line path is arranged adjacent to the first edge of the first aperture adjacent to the first fence of the conductive vias, and
the second transmission line path is arranged adjacent to a first edge of the second aperture adjacent to the first fence of the conductive vias, and.

9. The antenna module of claim 1, wherein a seventh gap is a distance between a first edge of the second patch element and a first edge of the second aperture,
an eighth gap is a distance between the second transmission line path and the first fence of the conductive vias,
a ninth gap is a distance between the first transmission line path and a first edge of the fourth aperture, and
a distance of the eighth gap is longer than a distance of the seventh gap, and a distance of the ninth gap is longer than the distance of the seventh gap.

10. The antenna module of claim 1, wherein the plurality of patch antenna elements comprise a plurality of antenna unit cells, each antenna unit cell comprising a fence of conductive vias, and
the fence of the conductive vias extends from the second conductive layer to the first conductive layer through the dielectric substrate, and the fence of the conductive vias, the first conductive layer, and the second conductive layer define a cavity.

11. (canceled)

12. An antenna module comprising:
a dielectric cover layer;
a dielectric substrate having a surface mounted to oppose the dielectric cover layer; and
a first conductive layer having a first aperture and a second aperture on the surface of the dielectric substrate;
a second conductive layer having a third aperture and a fourth aperture inside the dielectric substrate; and
a phased array antenna arranged on the dielectric substrate,
wherein the phased array antenna comprises a plurality of patch antenna elements on the surface of the dielectric substrate,
the phased array antenna is configured to transmit radio-frequency signals at a frequency between 10 GHz and 300 GHz through the dielectric cover layer,
a first antenna of the plurality of patch antenna elements comprises a first parasitic patch element for the first antenna on the surface of the dielectric substrate, a first patch element in the dielectric substrate, ground traces embedded in the dielectric substrate, and a first transmission line path coupled to a first positive antenna feed on the first patch element,
a second antenna of the plurality of patch antenna elements comprises a second parasitic patch element for the second antenna on the surface of the dielectric substrate, a second patch element in the dielectric substrate, ground traces embedded in the dielectric substrate, and a second transmission line path coupled to a second positive antenna feed on the first patch element,
a first fence of conductive vias in the dielectric substrate is interposed between the first antenna and the second antenna and is connected to a ground,
the first fence of the conductive vias extends to a first conductive surface mounted to oppose the dielectric cover layer,
the first patch element is aligned with the first aperture, the second patch element is aligned with the second aperture, the first transmission line path is aligned with the third aperture, and the second transmission line path is aligned with the fourth aperture,
a first gap is a distance between the first parasitic patch element and an edge of the first aperture, a second gap is a distance between the first patch element and the edge of the first aperture, a third gap is a distance between the first transmission line path and the first fence of the conductive vias, a third gap is a distance between the first transmission line path and the first fence of the conductive vias, and a fourth gap is a distance between the first transmission line path and an edge of the third aperture, and
a distance of the third gap is longer than a distance of the second gap, the distance of the second gap is longer than a distance of the first gap, and the distance of the third gap is longer than a distance of the fourth gap.

13. The antenna module of claim 12, wherein the first fence of the conductive vias and additional fences of conductive vias are interposed between the first conductive layer and the second conductive layer, and
the first fence of the conductive vias and the additional fences of the conductive vias are connected to the first conductive layer and the second conductive layer,
the first fence of the conductive vias and the additional fences of the conductive vias comprise a set of conductive vias having a shape selected from a group consisting of square shapes,
the additional fences of the conductive vias comprise a second fence of conductive vias, a third fence of conductive vias, and a fourth fence of conductive vias,
the first fence of the conductive vias opposes the third fence of the conductive vias, and
the second fence of the conductive vias opposes the fourth fence of the conductive vias.

14. The antenna module of claim 13, wherein the second fence of the conductive vias is arranged adjacent to the first fence of the conductive vias,
the first gap is a distance between a first edge of the first patch element and a first edge of the first aperture adjacent to the first fence of the conductive vias,
a fifth gap is a distance between a second edge of the first patch element and a second edge of the first aperture adjacent to the second fence of the conductive vias, and
the distance of the first gap is longer than a distance of the fifth gap.

15. The antenna module of claim 14, wherein the first fence of the conductive vias opposes the third fence of the conductive vias, and
a sixth gap is a distance between a third edge of the first patch element and a third edge of the first aperture adjacent to the third fence of the conductive vias, and
the distance of the first gap is equal or similar to a distance of the sixth gap.

16. The antenna module of claim 14, wherein the second fence of the conductive vias opposes the fourth fence of the conductive vias,
a seventh gap is a distance between a fourth edge of the first patch element and a fourth edge of the first aperture adjacent to the fourth fence of the conductive vias, and
the distance of the fifth gap is equal or similar to a distance of the seventh gap.

17. The antenna module of claim 12, wherein the first transmission line path is arranged adjacent to a first edge of the first aperture adjacent to the first fence of the conductive vias, and
the second transmission line path is arranged adjacent to a first edge of the second aperture adjacent to the first fence of the conductive vias, and.

18. The antenna module of claim 12, wherein an eighth gap is a distance between a first edge of the second parasitic patch element and a first edge of the second aperture,
a ninth gap is a distance between a first edge of the second patch element and a first edge of the second aperture,
a tenth gap is a distance between the second transmission line path and the first fence of the conductive vias,
an eleventh gap is a distance between the second transmission line path and a first edge of the fourth aperture, and
a distance of the tenth gap is longer than a distance of the ninth gap, the distance of the ninth gap is longer than a distance of the eighth gap, and the distance of the tenth gap is longer than a distance of the eleventh gap.

19. The antenna module of claim 12, wherein the plurality of patch antenna elements comprise a plurality of antenna unit cells, each antenna unit cell comprising a fence of conductive vias, and
the fence of the conductive vias extends from the second conductive layer to the first conductive layer through the dielectric substrate, the fence of the conductive vias, the first conductive layer, and the second conductive layer define a cavity, and the respective patch elements are formed in the cavity.

20. The antenna module of claim 12, wherein the dielectric cover layer has thickness and dielectric constant that constitute the dielectric cover layer to form a quarter wave impedance transformer between the phased array antennas.

21-32. (canceled)
